(19) United States
(12) Patent Application Publication
(10) Pub. No.: US 2025/0343301 A1
(43) Pub. Date: Nov. 6, 2025

(54) Electric Vehicle Battery With Thermal Failure Protection

(71) Applicant: Ample, Inc., San Francisco, CA (US)

(72) Inventors: Raymond Tsang, Daly City, CA (US); Albert Liu, San Francisco, CA (US); Caleb Tseng-Tham, Palo Alto, CA (US); Shahrul Song, San Bruno, CA (US); Henry Smith, San Francisco, CA (US); Erid Pineda, San Francisco, CA (US); Saideep Vollala, San Francisco, CA (US)

(21) Appl. No.: 19/197,403

(22) Filed: May 2, 2025

Related U.S. Application Data
(60) Provisional application No. 63/641,604, filed on May 2, 2024.

(51) Int. Cl. H01M 10/658; B60K 1/04; B60L 50/64; H01M 10/659; H01M 50/213; H01M 50/291; H01M 50/298

(52) U.S. Cl. CPC H01M 10/658; B60K 1/04; B60L 50/64; H01M 10/659; H01M 50/213; H01M 50/291; H01M 50/298; B60K 2001/0438; H01M 2220/20

(57) ABSTRACT

A battery module includes multiple battery-cell stacks of battery cells. The respective battery cells in the battery-cell stacks are spatially aligned with each other along respective longitudinal axes. The battery cells are oriented such that a positive terminal of a battery cell in one of the battery-cell stacks is spatially aligned with a negative terminal of a battery cell in a neighboring battery-cell stack. The battery-cell stacks are spaced apart to form respective air gaps between neighboring battery-cell stacks. A respective electrical connection layer is disposed on each side of a battery-cell stack to electrically connect the respective battery cells. A respective thermal protection shield is disposed on the respective electrical connection layer. The thermal protection shield includes channels that are spatially aligned with the positive terminals to allow gas and/or thermal energy to escape from a positive terminal in the event of battery-cell damage or breakdown.

### CROSS-REFERENCE TO RELATED APPLICATIONS

This application claims priority to U.S. Provisional Application No. 63/641,604, titled “Electric Vehicle Battery With Thermal Failure Protection,” filed on May 2, 2024, which is hereby incorporated by reference.

### TECHNICAL FIELD

This application relates generally to batteries for electric vehicles.

### BACKGROUND

Electric vehicles powered fully or partially with stored electric power from batteries come in numerous forms. Such vehicles can carry persons, cargo and/or other materials and include electric and/or hybrid road vehicles (e.g., cars, trucks, buses, vans, robotic wheeled equipment, motorbikes, scooters, etc.) as well as sea-going vessels (ships, submarines, etc.) and even airborne vessels (planes, drones, etc.) all of which are herein considered “vehicles.” However, those skilled in the art may appreciate the applicability of the present concepts to other systems, machines or equipment powered by batteries.

The batteries supporting and powering electric vehicles and other equipment can be constructed in any way that suits the power, energy storage, form factor, capacity, or other electric, mechanical, chemical, or economic needs of an application. Generally, such batteries store electrical energy, i.e., as stored electrical charge, in a package that is capable of being charged (depositing energy into the battery) and discharged (taking energy out of the battery).

Most battery systems comprise a number of individual battery cells that are organized, packed, assembled and electrically connected in an overall battery module for example by connecting several battery cells in series and/or parallel with other cells to achieve a desired voltage, capacity or other performance design objective. Furthermore, battery assemblies or packs are typically provided in a manufactured housing or casing that protects the assembly and its internal components from mechanical damage or environmental exposure. This can be problematic if one cell or a group of cells within a packaged assembly experiences an incident such as overheating or combustion or chemical degradation, which can then spread to all or some adjoining cells and cause a greater incident and even propagation or runaway thermal event in some instances.

The flow of current and other chemical activity in and out of the battery and in the internal structures thereof is known to generate heat from exothermic chemical events, electrical i²R current resistance losses and other physical effects. Cooling or removal of waste heat due to radiation, conduction and convection can be accomplished passively or actively as necessary and depending on the battery, use and environment, to avoid damage to the battery or vehicle. However, if an excessive rate of heat generation or thermal runaway occurs within a battery cell or system, this can result in catastrophic damage to the battery or other components. For example, overheating resulting from leaking chemical components or excess current flow (e.g., in a short circuit scenario) can cause physical damage to the structure of the battery, melting of metal, plastic or other components, fires, or even explosions of flammable or explosive gasses (e.g., hydrogen) depending on the situation. The extreme heat event in a battery cell can cause damage or secondary explosions and short circuiting of adjacent battery cells that further exacerbates the incident and can cause severe structural damage to a battery system, loss of the electric vehicle (e.g., by fire), or even injury or death of an occupant of the vehicle.

Therefore, it is of importance to design electric vehicle systems, especially battery systems, with the goal of avoiding or mitigating the effects of overheating and related incidents that are theoretically possible in these environments.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a battery module comprising a plurality of battery-cell stacks, each battery-cell stack including a plurality of battery cells, the battery cells arranged such that at least some positive terminals of the battery cells are disposed on a respective first side of a respective battery-cell stack and at least some negative terminals of the battery cells are disposed on a respective second side of the respective battery-cell stack, the respective first and second sides on opposing sides of the respective battery-cell stack; a plurality of first thermal-protection shields, each first thermal-protection shield disposed on the respective first side of the respective battery-cell stack; and a plurality of second thermal-protection shields, each second thermal-protection shield disposed on the respective second side of the respective battery-cell stack, wherein the battery-cell stacks include at least one neighboring battery-cell stack pair, a respective air gap is defined between (a) a respective first thermal-protection shield on the respective first side of a first battery-cell stack in a respective battery-cell stack pair and (b) a respective second thermal-protection shield on the respective second side of a second battery-cell stack in the respective battery-cell stack pair, a plurality of holes are defined in each first thermal-protection shield, the holes spatially aligned with the at least some positive terminals on the respective first side of the first battery-cell stack in each battery-cell stack pair such that each positive terminal on the respective first side of each first battery-cell stack is at least partially fluidly coupled to the respective air gap, and the respective second thermal-protection shield covers the at least some negative terminals side on the respective second side of the second battery-cell stack in each battery-cell stack pair such that each negative terminal on the respective second side of each second battery-cell stack is shielded from a thermal event occurring at any of the at least some positive terminals on the respective first side of each first battery-cell stack.

In one or more embodiments, each of the first and second thermal protection shields comprises first and second electrically insulating layers and at least one heat absorption layer disposed between the first and second electrically insulating layers. In one or more embodiments, the first and second electrically insulating layers comprise an epoxy laminate, mica, and/or a thermoplastic, and the at least one heat absorption layer comprises metal and/or graphite. In one or more embodiments, the metal comprises stainless steel.

In one or more embodiments, the battery module further comprises a plurality of support frames, each support frame defining a plurality of battery-cell cavities, each battery-cell cavity in a respective support frame configured to receive a respective battery cell from the respective battery-cell stack. In one or more embodiments, each support frame is comprised of one or more metals.

In one or more embodiments, the battery cells in the battery-cell stacks are spatially aligned along longitudinal axes, each longitudinal axis passing through respective terminals of a respective battery cell in each battery-cell stack. In one or more embodiments, respective battery cells that are spatially aligned along a respective longitudinal axis have the same polarity orientation. In one or more embodiments, a respective air channel is defined through each support frame, each air channel fluidly coupled to the respective air gap.

Another aspect of the invention is directed to a battery module comprising a plurality of battery-cell stacks, each battery-cell stack including battery cells, the battery cells in the battery-cell stacks spatially aligned along longitudinal axes, each longitudinal axis passing through respective terminals of a respective battery cell in each battery-cell stack, the longitudinal axes parallel to one another; a plurality of first electrical wiring layers, each first electrical wiring layer disposed on a first side of a respective battery-cell stack and in electrical contact with each battery cell in the respective battery-cell stack; a plurality of second electrical wiring layers, each second electrical wiring layer disposed on a second side of the respective battery-cell stack and in electrical contact with each battery cell in the respective battery-cell stack; a plurality of first thermal-protection shields, each first thermal-protection shield disposed on a respective first electrical wiring layer; and a plurality of second thermal-protection shields, each second thermal-protection shield disposed on a respective second electrical wiring layer, wherein the battery-cell stacks include at least one neighboring battery-cell stack pair, a respective air gap is defined between (a) a respective first thermal-protection shield on the first side of a first battery-cell stack in a respective battery-cell stack pair and (b) a respective second thermal-protection shield on the second side of a second battery-cell stack in the respective battery-cell stack pair, a plurality of first channels are defined in the respective first thermal-protection shield, each first channel fluidly coupling a respective positive terminal of each battery cell that has the respective positive terminal on the first side of the first battery-cell stack in the respective battery-cell stack pair to the respective air gap, and a plurality of second channels are defined in the respective second thermal-protection shield, each second channel fluidly coupling the respective positive terminal of each battery cell that has the respective positive terminal on the second side of the second battery-cell stack in the respective battery-cell stack pair to the respective air gap.

In one or more embodiments, respective battery cells that are spatially aligned along a respective longitudinal axis have the same polarity orientation. In one or more embodiments, a plurality of first holes are defined in each first electrical wiring layer, each first hole spatially aligned with the respective positive terminal of each battery cell that has the respective positive terminal on the first side of the respective battery-cell stack, and a plurality of second holes are defined in each second electrical wiring layer, each second hole spatially aligned with the respective positive terminal of each battery cell that has the respective positive terminal on the second side of the respective battery-cell stack.

In one or more embodiments, each first electrical wiring layer includes a plurality of first positive electrical tabs, each first positive electrical tab configured to electrically contact the respective positive terminal of each battery cell that has the respective positive terminal on the first side of the respective battery-cell stack, wherein each first hole is defined in a respective first positive electrical tab, and each second electrical wiring layer includes a plurality of second positive electrical tabs, each second positive electrical tab configured to electrically contact the respective positive terminal of each battery cell that has the respective positive terminal on the second side of the respective battery-cell stack, wherein each second hole is defined in a respective second positive electrical tab. In one or more embodiments, each first electrical wiring layer includes a plurality of first negative electrical tabs, each first negative electrical tab configured to electrically contact a respective negative terminal of each battery cell that has the respective negative terminal on the first side of the respective battery-cell stack, and each second electrical wiring layer includes a plurality of second negative electrical tabs, each second negative electrical tab configured to electrically contact the respective negative terminal of each battery cell that has the respective negative terminal on the second side of the respective battery-cell stack. In one or more embodiments, the first and second holes are first and second positive holes, respectively, a plurality of first negative holes are defined in each first electrical wiring layer, each first negative hole spatially aligned with the respective negative terminal of each battery cell that has the respective negative terminal on the first side of the respective battery-cell stack, each first negative hole defined in a respective first negative electrical tab, and a plurality of second negative holes are defined in each second electrical wiring layer, each second negative hole spatially aligned with the respective negative terminal of each battery cell that has the respective negative terminal on the second side of the respective battery-cell stack, each second negative hole defined in a respective second negative electrical tab.

Another aspect of the invention is directed to a battery module comprising a plurality of support frames, each support frame defining a plurality of battery-cell cavities; a plurality of battery cells, each battery cell disposed in a respective battery-cell cavity of a respective support frame to form a plurality of battery-cell stacks, the support frames configured such that each battery cell is oriented such that a respective axis pass through the respective terminals of a respective battery cell, the respective axes parallel to one another; a plurality of first electrical wiring layers, each first electrical wiring layer disposed on a first side of a respective battery-cell stack and in electrical contact with each battery cell in the respective battery-cell stack; a plurality of second electrical wiring layers, each second electrical wiring layer disposed on a second side of the respective battery-cell stack and in electrical contact with each battery cell in the respective battery-cell stack; a plurality of first thermal-protection shields, each first thermal-protection shield disposed on a respective first electrical wiring layer; and a plurality of second thermal-protection shields, each second thermal-protection shield disposed on a respective second electrical wiring layer, wherein a respective air gap is defined between (a) a respective first thermal-protection shield on the first side of a first battery-cell stack in a respective neighboring battery-cell stack pair and (b) a respective second thermal-protection shield on the second side of a second battery-cell stack in the respective neighboring battery-cell stack pair, the battery cells in each battery-cell stack includes one or more first battery cells, each first battery cell oriented such that a respective positive terminal of a respective first battery cell is on the first side of the respective battery-cell stack and a respective negative terminal of the respective first battery cell is on the second side of the respective battery-cell stack, the battery cells in each battery-cell stack includes one or more second battery cells, each second battery cell oriented such that the respective positive terminal of a respective second battery cell is on the second side of the respective battery-cell stack and the respective negative terminal of the respective second battery cell is on the first side of the respective battery-cell stack, each negative terminal on the second side of the second battery-cell stack is spatially aligned with the respective positive terminal on the first side of the second battery-cell stack, one or more first holes is/are defined in each first electrical wiring layer, each first hole spatially aligned with the respective positive terminal of the respective first battery cell, and one or more second holes is/are defined in each second electrical wiring layer, each second hole spatially aligned with the respective positive terminal of the respective second battery cell.

In one or more embodiments, each of the first and second thermal protection shields comprises first and second electrically insulating layers and at least one heat absorption layer disposed between the first and second electrically insulating layers. In one or more embodiments, a respective air channel is defined through each support frame, each air channel fluidly coupled to the respective air gap. In one or more embodiments, the respective air channels through the support frames are spatially aligned.

Another aspect of the invention is directed to an electric vehicle comprising an interface plate attached to a bottom of the electric vehicle, the interface plate electrically coupled to a drive train of the electric vehicle; a battery tray releasably attached to the interface plate; and a battery module as described herein, the battery module disposed on the battery tray and electrically coupled to the interface plate.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a bottom view of a simplified illustrative electric vehicle according to one or more embodiments.

FIG. 2 is a top view of a battery tray holding two battery modules according to one or more embodiments.

FIGS. 3 and 4 are isolated isometric exploded views of a plurality of battery-cell stack from first and second perspectives.

FIG. 5 is a side view of a support structure for a battery-cell stack according to one or more embodiments.

FIG. 6 is a cross section of a battery cell and a respective battery-cell cavity in FIG. 5 according to one or more embodiments.

FIG. 7 is a top view of a battery module according to one or more embodiments.

FIGS. 8A, 8B, and 8C are block diagrams of a thermal-protection shield according to one or more embodiments.

FIG. 9 is a top view of an electrical bus layer according to one or more embodiments.

FIGS. 10A-10C are isolated exploded views of positive and negative conductive caps and an example battery cell according to one or more alternative embodiments.

FIG. 11 is a partially exploded isometric view of a battery module according to one or more embodiments.

FIG. 12 is a simplified cross section of the battery module in FIG. 11 according to one or more embodiments.

FIG. 13 is a detailed view of cross section shown in FIG. 12 according to one or more embodiments.

FIG. 14 is a detailed view of cross section shown in FIG. 12 according to one or more alternative embodiments.

### DETAILED DESCRIPTION

A battery module includes battery cells that are arranged in respective battery-cell stacks. The battery cells can be mounted or placed in respective cavities of a respective support structure to form each battery-cell stack. The battery cells have a length measured along respective axes that pass through the respective terminals at opposing ends of the respective battery cells. The battery cells are spatially oriented in parallel with each other such that the respective axes are parallel to one another.

The battery cells in respective positions and/or locations of the battery-cell stacks can be spatially aligned along or relative to the respective axes, such that the respective axes of the battery cells in respective positions and/or locations of the battery-cell stacks are collinear and/or form a respective longitudinal axis. In addition, the battery cells in respective positions and/or locations of the battery-cell stacks can have the same polarity orientation such that all battery cells in respective positions and/or locations (e.g., that are spatially aligned) have respective positive terminals facing a first direction and respective negative terminals facing a second direction that is opposite to the first direction. When the battery cells in respective positions and/or locations of the battery-cell stacks have the same polarity orientation, a positive terminal of a battery cell in one battery-cell stack faces or opposes a negative terminal of a neighboring battery cell stack.

The battery cells in each battery-cell stack are electrically connected to first and second wiring layers on opposing first and second sides of each battery-cell stack. Conductive caps in the first and second wiring layers can electrically contact the positive and negative terminals of the battery cells in each battery-cell stack.

First and second thermal-protection shields are disposed on the first and second wiring layers, respectively. Each thermal-protection shield includes holes and/or channels that are spatially aligned the positive terminals of the battery cells in the respective battery cell stack that face the side (e.g., first or second side) where the thermal-protection shield is located. For example, the first thermal-protection shield includes holes and/or channels that are spatially aligned the positive terminals on the first side of the respective battery cell stack. The second thermal-protection shield includes holes and/or channels that are spatially aligned the positive terminals on the second side of the respective battery cell stack.

When a thermal battery-cell event occurs in a given battery cell, gas, thermal energy, and/or particular matter (e.g., battery-cell material such as battery-cell innards and/or molten metal that may emerge from the battery cell) can escape the battery cell from its positive terminal. The gas and/or thermal energy can pass into the air gap between neighboring battery-cell stacks through the hole and/or channel in the thermal-protection shield that is spatially aligned with the positive terminal of the battery cell undergoing the thermal battery-cell event. The thermal-protection shield protects and the negative terminal of the battery cell in the neighboring battery-cell stack that is spatially aligned with the positive terminal of the battery cell undergoing the thermal battery-cell event. The thermal-protection shield also protects the negative terminals of any other battery cells that are nearby to the battery cell undergoing the thermal battery-cell event in the same battery-cell stack and/or in the neighboring battery-cell stack.

One more channels can extend through each support structure and/or through each battery-cell stack. The channels are configured to fluidly connect and/or fluidly couple the air gaps on each side of a respective battery-cell stack. The channels can allow gas, thermal energy, and/or pressure to flow into and/or dissipate through some or all of the air gaps to reduce and/or eliminate damage to the battery module.

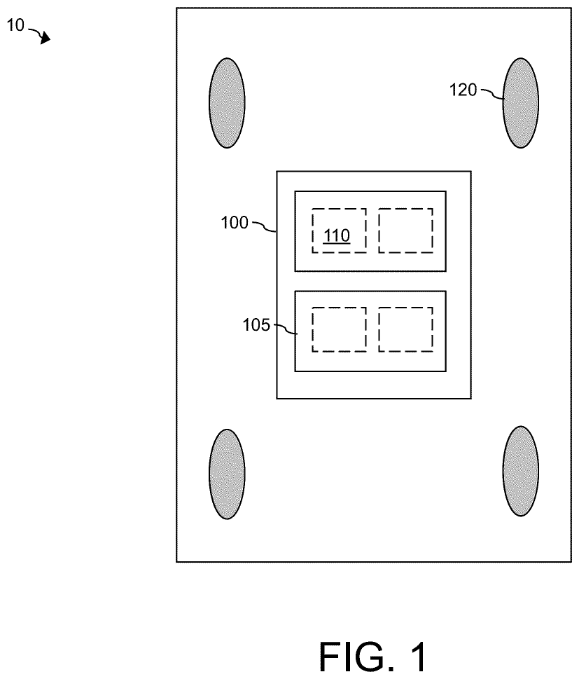

FIG. 1 is a bottom view of a simplified illustrative electric vehicle (EV) 10 according to one or more embodiments. The EV 10 can comprise a passenger vehicle, a truck, or another vehicle. Though shown with four wheels 120, the EV 10 can include additional or fewer wheels 120. For example, the EV 10 can include two wheels 120 such as an electric motorcycle, an electric moped, or another electrically powered two-wheeled vehicle. The EV 10 can include additional wheels 120 to support a heavier load such as in an electrically powered truck or construction vehicle.

The EV 10 can include an interface plate 100 attached to the bottom of the EV 10. Multiple battery trays 105 can be releasably attached to the interface plate 100. Each battery tray 105 includes one or more battery modules (BMs) 110. A BM 110 can alternately be referred to as an EV battery 110. The interface plate 100 is electrically coupled to the BMs 110 in each battery tray 105 and to the drive train of the EV 10 such that electric energy from the BMs 110 can be used to power the EV 10, for example to drive one or more motors in the EV 10. When the BMs 110 are low in energy, one or more BMs 110 (e.g., the BM(s) 110 in a given battery tray 105) can be replaced or swapped with charged BMs. The battery modules 110 are between each battery tray 105 and the interface plate 100 and are shown in dashed lines for illustration purposes only. An example of an interface place 100 is disclosed in U.S. Pat. No. 11,858,328, titled “Interface For Coupling Electric Battery And Vehicle Systems,” which is hereby incorporated by reference.

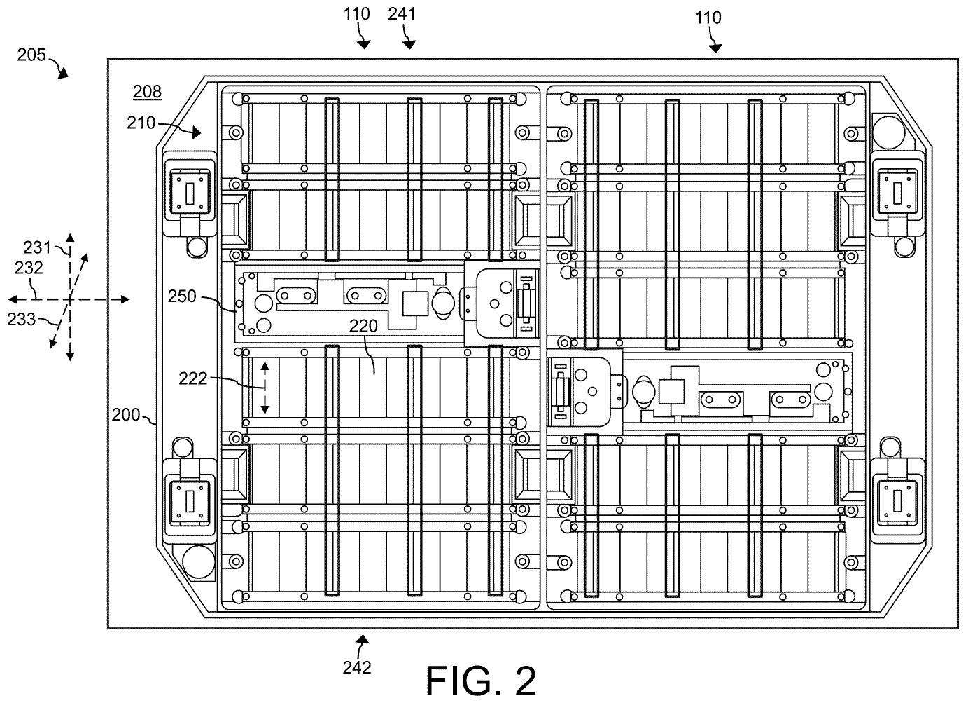

FIG. 2 is a top view of a battery tray 205 holding two BMs 110 according to one or more embodiments. The battery tray 205 can be the same as one or either of the battery trays 105. Each BM 110 includes a respective housing 200 that holds multiple stacks, groups, or modules (in general, stacks) 210 of individual battery cells 220. The top of the housing 200 is removed to show the battery cells 220. In practice, the housing 200 includes a top cover so as to enclose the battery cells 220, associated electrical connections, electrical components, and/or wires disposed in the BM 110. For example, the housing 200 can provide a watertight seal to prevent water, dirt, and/or debris from damaging the BM 110 (e.g., the battery cells 220) for example while attached to an EV 10.

Each battery cell 220 has an elongated length. The battery cells 220 within a BM 110 are arranged in the same orientation such that the lengths of all battery cells 220 can be measured with respect to a first axis 231. In one or more embodiments, the battery cells 220 in both BMs 110 are arranged in the same orientation such that the lengths of all battery cells 220 in both BMs 110 can be measured with respect to the first axis 231, for example as shown in FIG. 2.

Additionally or alternatively, the length of each battery cell 220 can be measured with respect to a respective longitudinal axis 222. Within a BM 110, the longitudinal axes 222 are parallel to each other (or substantially parallel to each other such as within 0.1 degrees to 5 degrees of each other) and to the first axis 231. In one or more embodiments, the longitudinal axes 222 of the battery cells 220 in both BMs 110 are parallel to each other (or substantially parallel to each other such as within 0.1 degrees to 5 degrees of each other) and to the first axis 231.

In one or more alternative embodiments, the battery cells 220 in one of the BMs 110 are not in the same orientation as the battery cells 220 in the other BM 110. For example, the length of each battery cell 220 in one of the BMs 110 can be measured with respect to the first axis 231 and the length of each battery cell 220 in the other BM 110 can be measured with respect to a second axis 232 that is orthogonal to the first longitudinal axis 231. The first and second axes 231, 232 can define a plane that is parallel to a side 208 of the battery tray 205 that supports the BMs 110.

It is noted that although the battery cells 220 within a BM 110 have the same orientation with respect to the battery-cell lengths and/or the longitudinal axes 222 of the battery cells 220, one or more battery cells 220 (e.g., first battery cells) can be oriented such that its/their positive terminal(s) is/are facing a first side 241 of the BM 110 and its/their negative terminal(s) is/are facing a second side 242 of the BM 110 while one or more other battery cells 220 (e.g., second battery cells) can be oriented such that its/their negative terminal(s) is/are facing the first side 241 of the BM 110 and its/their positive terminal(s) is/are facing the second side 242 of the BM 110. Thus, the polarity orientation of one or more battery cells 220 can be inverted, reversed, and/or alternating relative to one or more other battery cells 220 in a BM 110.

Each battery-cell stack 210 can be vertically stacked such that additional battery cells 220 can be located below (e.g., along or parallel to a third axis 233 that is orthogonal to the first and second axes 231, 232) the battery cells 220 shown in FIG. 2.

Each BM 110 can include a respective BM controller 250 that can be disposed between a pair of battery-cell stacks 210. The BM controller 250 can include active as well as passive electronic components such as microcontrollers, field-effect transistors (FETs), and/or short-circuit protection to provide and/or enable at least some of the electrical functionality of a respective BM 110.

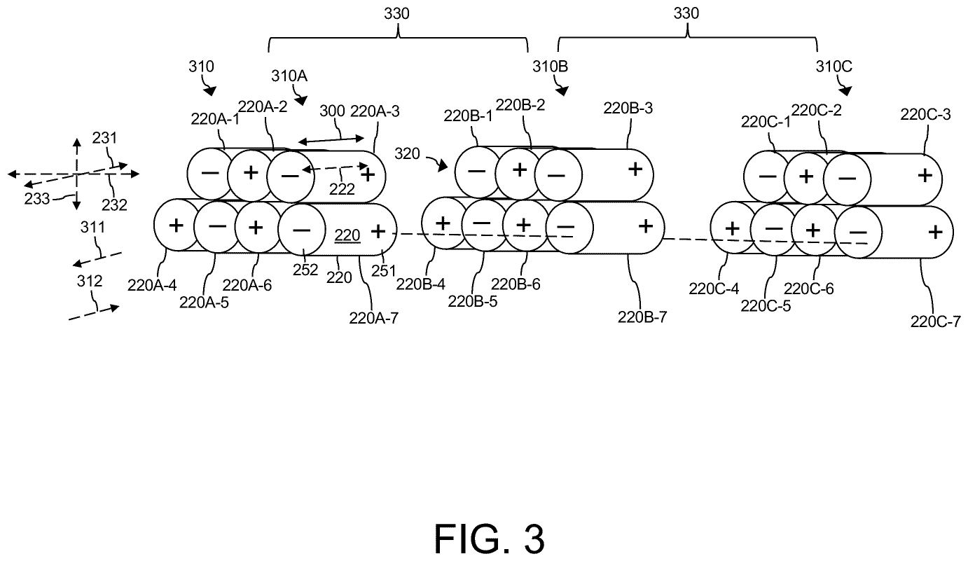

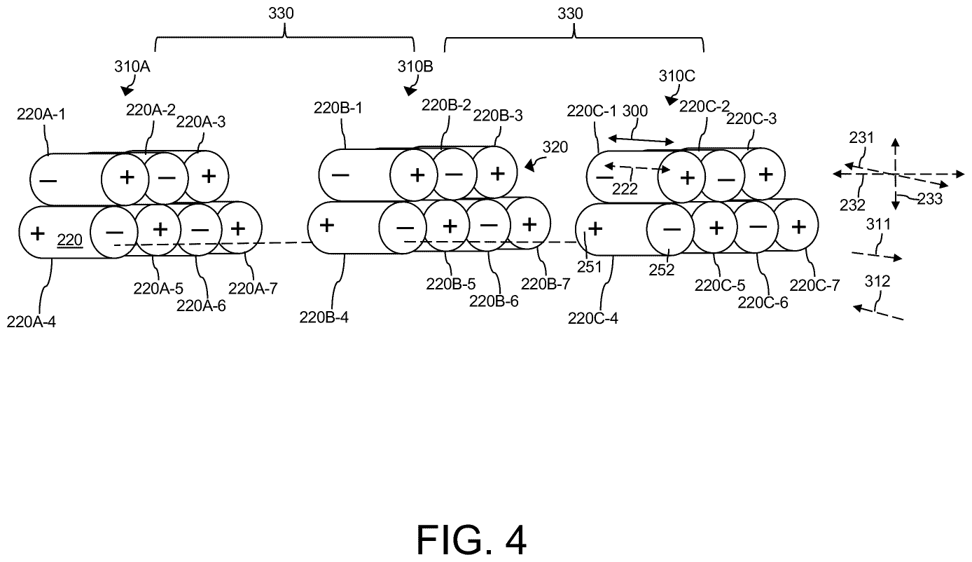

FIGS. 3 and 4 are isolated isometric exploded views of a plurality of battery-cell stack 310A-310C (in general, battery-cell stack(s) 310) from first and second perspectives. Each battery-cell stack 310A-310C can be the same as or different than a battery-cell stack 210. Each battery cell stack 310 includes battery cells 220 that are stacked horizontally

Each battery cell 220 has a respective length 300 that is measured between a respective positive terminal 251 and a respective negative terminal 252 of a given battery cell 220. The respective lengths 300 for all battery cells 220 can be the same in one or more embodiments. Each length 300 can be measured with respect to the respective longitudinal axis 222 of a respective battery cell 220, which is parallel to the first axis 231 (e.g., as discussed with respect to FIG. 2).

Each battery cell stack 310 includes a plurality of battery cells 220 that are disposed adjacent to each other and/or spaced along the second axis 232 to form a horizontal row 320. Each battery cell stack 310 includes a plurality of rows 320. Though only two (e.g., top and bottom) rows 320 are shown in FIG. 3 for ease of illustration purposes, there can be additional rows 320 and/or additional battery cells 220 in a given row 320 in one or more embodiments.

The battery cells 220 in a respective battery-cell stack 310 are configured and/or arranged such that each battery cell 220 is spatially aligned, along or parallel to the first axis 231, with a corresponding/respective battery cell 220 in at least the neighboring battery-cell stack(s) 310 that is/are adjacent and/or immediately adjacent to the respective battery-cell stack 310. There are no intervening or intermediate battery cell stacks 310 between a neighboring battery-cell stack pair 330.

For example, battery-cell stacks 310A, 310B form a first neighboring battery-cell stack pair 330. Battery cells 220A-1, 220A-2, and 220A-3 in the top row 320 of battery-cell stack 310A are spatially aligned, along or parallel to the first axis 231, with battery cells 220B-1, 220B-2, and 220B-3, respectively, in the top row 320 of battery-cell stack 310B. Battery cells 220A-4, 220A-5, 220A-6, and 220A-7 in the bottom row 320 of battery-cell stack 310A are spatially aligned with battery cells 220B-4, 220B-5, 220B-6, and 220B-7, respectively, in the bottom row 320 of battery-cell stack 310B.

Each pair of spatially aligned battery cells 220 (e.g., at a corresponding/respective position) in the first neighboring battery-cell stack pair 330 has the same polarity orientation. For example, battery cells 220A-1, 220B-1 comprise a first pair of spatially aligned battery cells 220. The negative terminal 252 of each battery cell 220A-1, 220B-1 is oriented to face a first direction 311, and the positive terminal 251 of each battery cell 220A-1, 220B-1 is oriented to face a second direction 312. The first and second directions 311, 312 are opposite to each other and are parallel and/or relative to the first axis 231 and/or the respective longitudinal axes 222 of the battery cells 220A-1, 220B-1. The first and second directions 311, 312 can correspond to and/or be the same as the first and second sides 241, 242 of the BM 110 (FIG. 2).

In one example, the negative terminal 252 of battery cell 220B-1 and the positive terminal 251 of battery cell 220A-1 face and/or oppose one another. For example, the negative terminal 252 of battery cell 220B-1 is located closer to the positive terminal 251 of battery cell 220A-1 than to the negative terminal 252 of battery cell 220A-1. In addition, the positive terminal 251 of battery cell 220A-1 is located closer to the negative terminal 252 of battery cell 220B-1 than to the positive terminal 251 of battery cell 220B-1.

In another example, the positive terminal 251 of battery cell 220B-2 and the negative terminal 252 of battery cell 220A-2 face and/or oppose one another. For example, the positive terminal 251 of battery cell 220B-2 is located closer to the negative terminal 252 of battery cell 220A-2 than to the positive terminal 251 of battery cell 220A-2. In addition, the negative terminal 252 of battery cell 220A-2 is located closer to the positive terminal 251 of battery cell 220B-1 than to the negative terminal 252 of battery cell 220B-2.

Battery-cell stacks 310B, 310C form a second neighboring battery-cell stack pair 330. Battery cells 220B-1, 220B-2, and 220B-3 in the top row 320 of battery-cell stack 310B are spatially aligned, along or parallel to the first axis 231, with battery cells 220C-1, 220C-2, and 220C-3, respectively, in the top row 320 of battery-cell stack 310C. Battery cells 220B-4, 220B-5, 220B-6, and 220B-7 in the bottom row 320 of battery-cell stack 310B are spatially aligned with battery cells 220C-4, 220C-5, 220C-6, and 220C-7, respectively, in the bottom row 320 of battery-cell stack 310C.

Each pair of spatially aligned battery cells 220 in the second neighboring battery-cell stack pair 330 has the same polarity orientation. For example, battery cells 220B-1, 220C-1 comprise a first pair of spatially aligned battery cells 220. The negative terminal 252 of each battery cell 220B-1, 220C-1 is oriented to face the first direction 311, and the positive terminal 251 of each battery cell 220B-1, 220C-1 is oriented to face the second direction 312.

In one example, the negative terminal 252 of battery cell 220C-1 and the positive terminal 251 of battery cell 220B-1 face and/or oppose one another. For example, the negative terminal 252 of battery cell 220C-1 is located closer to the positive terminal 251 of battery cell 220B-1 than to the negative terminal 252 of battery cell 220B-1. In addition, the positive terminal 251 of battery cell 220B-1 is located closer to the negative terminal 252 of battery cell 220C-1 than to the positive terminal 251 of battery cell 220C-1.

In another example, the positive terminal 251 of battery cell 220C-2 and the negative terminal 252 of battery cell 220C-2 face and/or oppose one another. For example, the positive terminal 251 of battery cell 220C-2 is located closer to the negative terminal 252 of battery cell 220B-2 than to the positive terminal 251 of battery cell 220B-2. In addition, the negative terminal 252 of battery cell 220B-2 is located closer to the positive terminal 251 of battery cell 220C-1 than to the negative terminal 252 of battery cell 220C-2.

In general, each battery-cell stack 310A-C can have the same configuration, spatial orientation, and/or polarity orientation of battery cells 230. Each battery-cell stack 310A-C can include a respective battery cell 220 that is spatially aligned along a respective longitudinal axis 222 that has the same polarity orientation. For example, battery-cell stacks 310A-C includes respective battery cells 220A-1, 220B-1, 220C-1 that are spatially aligned along a respective longitudinal axis 222, and each battery cell 220A-1, 220B-1, 220C-1 has a respective negative terminal 252 facing the first direction 311 and a respective positive terminal 251 facing the second direction 312. In another example, battery-cell stacks 310A-C includes respective battery cells 220A-2, 220B-2, 220C-2 that are spatially aligned along a respective longitudinal axis 222, and each battery cell 220A-2, 220B-2, 220C-2 has a respective negative terminal 252 facing the second direction 312 and a respective positive terminal 251 facing the first direction 311.

Battery cells 220A-3, 220A-5, 220A-7 are spatially aligned with battery cells 220B-3, 220B-5, 220B-7 and with battery cells 220C-3, 220C-5, 220C-7, respectively, with respect to respective longitudinal axes 222. Battery cells 220A-3, 220A-5, 220A-7 have the same polarity orientation as battery cells 220B-3, 220B-5, 220B-7, the same polarity orientation as battery cells 220C-3, 220C-5, 220C-7, and the same polarity orientation as 220A-1, 220B-1, 220C-1, respectively. Battery cells 220A-4, 220A-6 are spatially aligned with battery cells 220B-4, 220B-6 and with battery cells 220C-4, 220C-6, respectively, with respect to respective longitudinal axes 222. Battery cells 220A-4, 220A-6 have the same polarity orientation as battery cells 220B-4, 220B-6, the same polarity orientation as battery cells 220C-4, 220C-6, and the same polarity orientation as 220A-2, 220B-2, 220C-2, respectively. Battery cells 220A-1, 220A-3, 220A-5, 220A-7, battery cells 220B-1, 220B-3, 220B-5, 220B-7, and battery cells 220C-1, 220C-3, 220C-5, 220C-7 have the opposite or inverse polarity orientation relative to battery cells 220A-2, 220A-4, 220A-6, to battery cells 220B-2, 220B-4, 220B-6, and to battery cells 220C-2, 220C-4, 220C-6, respectively.

Along a respective longitudinal axis 222, the spatially aligned battery cells 220 are configured and arranged to have alternating positive and negative terminals 251, 252. For example, from left to right in FIG. 3 along the respective longitudinal axis 222 that passes through battery cells 220A-7, 220B-7, 220C-7, we see there is the negative terminal 252 of battery cell 220A-7, the positive terminal 251 of battery cell 220A-7, the negative terminal 252 of battery cell 220B-7, the positive terminal 251 of battery cell 220B-7, the negative terminal 252 of battery cell 220C-7, and the positive terminal 251 of battery cell 220B-7.

Though adjacent battery cells 220 in a given row 320 of a given battery-cell stack 310A-310C are shown as having the oppositive or inverse polarity orientations (e.g., battery cells 220A-1, 220A-2 have oppositive/inverse polarity orientations), it is noted that, in one or more embodiments, some or all adjacent battery cells 220 can have the same polarity orientations.

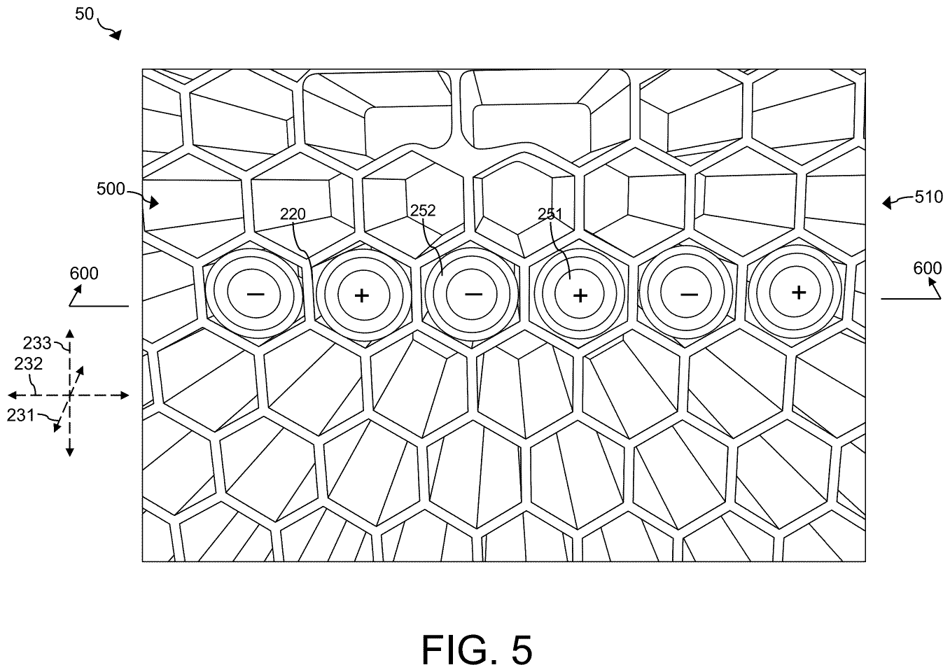

FIG. 5 is a side view of a support structure 50 for a battery-cell stack according to one or more embodiments. The support structure 50 includes or defines a plurality of battery-cell cavities 500 that are configured to receive, retain, and/or support respective battery cells 220. A plurality of example battery cells 220 in an example row 510 of battery-cell cavities 500 are shown for illustrative purposes only. In one or more embodiments, each battery-cell cavities 500 can receive, retain, and/or support a respective battery cell 220. The cavities 500 can have a hexagonal cross section and can be arranged in a honeycomb pattern or configuration, for example in a cross section of the support structure 50 taken through a plane that is parallel to the second and third axes 232, 233. In one or more alternative embodiments, the cavities 500 can have a circular cross section (e.g., in a cross section of the support structure 50 taken through a plane that is parallel to the second and third axes 232, 233). The cavities 500 are arranged in a plurality of rows 510 that can define the rows 320 of battery cells 220 in a battery cell stack 310 (e.g., as shown in FIGS. 3 and 4).

The support structure 50 can comprise or consist of a material that can provide structural support to the battery cells 220, is thermally conductive, and lightweight. The structural support can prevent side-rupture of a battery cell 220 during a thermal battery-cell event. In the event of a side-rupture, hot flames and gas emerging from the side-rupture can cause a thermal propagation event through the entire battery-cell stack and/or BM. Thermally conductivity of the support-structure material can provide overall thermal regulation of a battery cell stack and can dissipate thermal energy (e.g., heat) away from a battery cell 220 that goes into thermal runaway (during a thermal battery-cell event) to spread the heat across the battery-cell stack and the support structure 50, instead of having the thermal energy concentrated in a few nearest neighbor battery cells. The weight and/or density of the support-structure material can be reduced and/or minimized to reduce and/or minimize the overall weight of the structure 50 and of the BM. In one or more embodiments, the support-structure material can comprise or consist of aluminum.

The battery cells 220 can be disposed or mounted in a respective support structure 50 to form a respective battery-cell stack 210, 310A-310C. The cavities 500 are configured to spatially align battery cells 200 at respective relative positions/locations in the battery-cell stacks 210, 310A-310C and/or in neighboring battery-cell stack pairs 330.

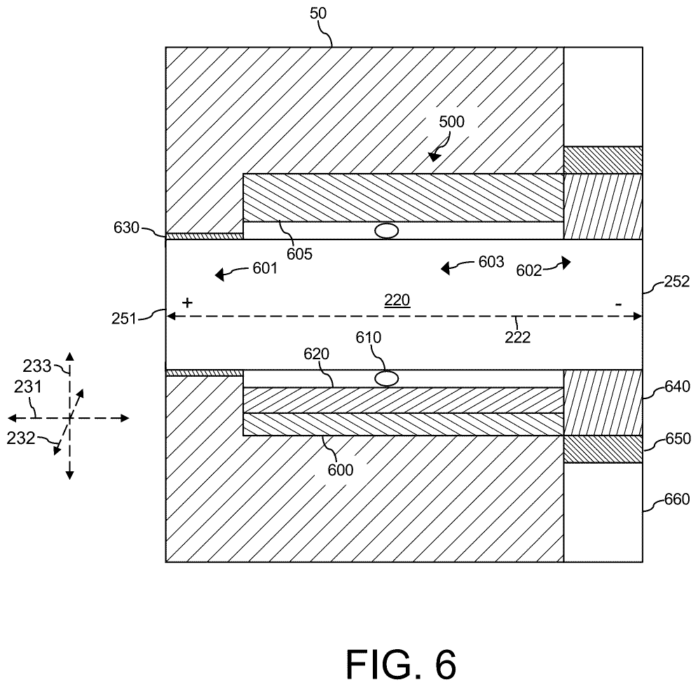

FIG. 6 is a cross section of one of the battery cells 220 and a respective battery-cell cavity 500 through plane 600 in FIG. 5 according to one or more embodiments. The battery cell 220 is disposed within a sleeve 605 that can comprise and/or can be an electrically insulating material such as polyethylene terephthalate (PET) and/or another material. An optional thermocouple 610 can be disposed within the sleeve 605. The thermocouple 610 can be in direct physical contact with the battery cell 220 for example at the middle or middle portion 603 of the battery cell 220. The thermocouple 610 can comprise a ring structure. An optional thermal pad 620 can be disposed on one side between the thermocouple 610 and the sleeve 605. The sleeve 605, the optional thermocouple 610, and the optional thermal pad 620 are disposed within the cavity 500 of the support structure 50. The optional thermocouple 610 and/or the optional thermal pad 620 can be omitted in one or more alternative embodiments.

An optional first bonding or adhesive layer 630 can be disposed around a first end 601 of the battery cell 220 at or proximal to the positive terminal 251. The optional first bonding/adhesive layer 630 can comprise and/or be formed of an epoxy adhesive such as DP100FR (available from the 3M Company). The first bonding/adhesive layer 630 is between the first end 601 of the battery cell 220 and the support structure 50. The first bonding/adhesive layer 630 can be omitted in one or more alternative embodiments.

A second bonding or adhesive layer 640 is disposed around a second end 602 of the battery cell 220 which can extend away and/or outside of the cavity 500. The second end 602 of the battery cell 220 is at or proximal to the negative terminal 252. The second bonding/adhesive layer 640 can comprise and/or be formed of the same material as the first bonding/adhesive layer 630. The second bonding/adhesive layer 640 is between a metal ring 650 and the second end 602 of the battery cell 220. The metal ring 650 is between the second bonding/adhesive layer 640 and an endcap 660.

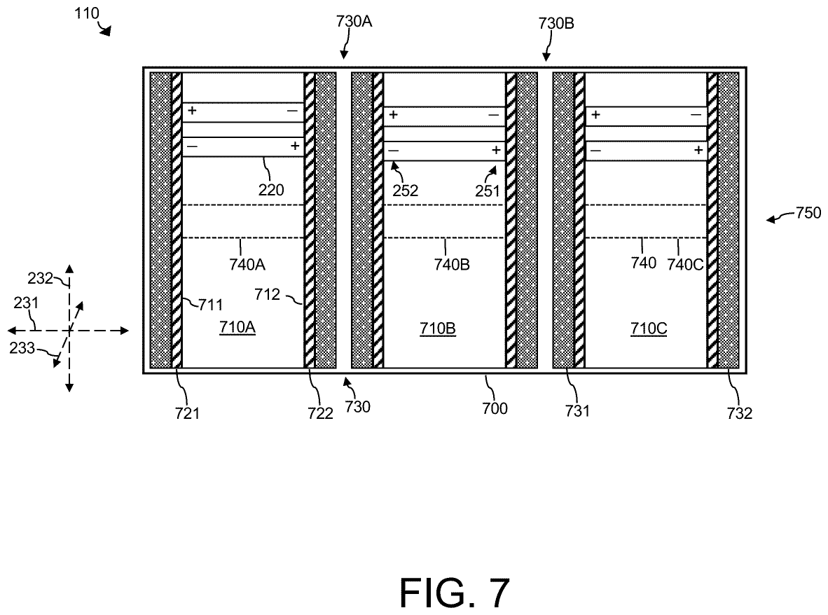

FIG. 7 is a top view of a BM 110 according to one or more embodiments. The BM 110 includes a plurality of battery-cell stacks 710A-710C (in general battery-cell stack(s) 710) that are disposed and/or mounted in a housing 700. Each battery-cell stack 710A-710C can be the same as or different than a battery-cell stack 310A-310C, respectively, and/or a battery-cell stack 210. In addition, a respective support structure 50 can support and/or form each battery-cell stack 710A-710C. The housing 700 can be the same as the housing 200.

Each battery-cell stack 710 includes opposing first and second sides 711, 712. Within a respective battery-cell stack 710, the positive terminal 251 or a negative terminal 252 of each battery cell 220 is located on the first or second side 711, 712 of the respective battery-cell stack 710.

A first electrical bus layer 721 is disposed on the first side 711 of each battery-cell stack 710. A second electrical bus layer 722 is disposed on the second side 712 of each battery-cell stack 710. Each electrical bus layer 721, 722 includes a plurality of positive and negative conductive caps that are configured and arranged to electrically contact respective positive and negative terminals 251, 252 of the battery cells 230 on the first and second sides 711, 712 of the battery-cell stack 710. The electrical bus layer 721, 722 also includes electrical wiring to electrically connect the positive and/or negative conductive caps in series and/or in parallel to produce a target voltage across the battery-cell stack 710.

A first thermal protection shield 731 is disposed on the first electrical bus layer 721 such that the first electrical bus layer 721 is between the first thermal protection shield 731 and the first side 711 of a respective battery-cell stack 710. A second thermal protection shield 732 is disposed on the second electrical bus layer 722 such that the second electrical bus layer 722 is between the second thermal protection shield 732 and the second side 712 of a respective battery-cell stack 710.

When a thermal battery-cell event (e.g., combustion and/or explosion) occurs in one of the battery cells 220, such as due to damage to or failure of a battery cell 220, the thermal protection shields 731, 732 are configured to protect nearby battery cells 220 from thermal damage. Typically, a thermal battery-cell event occurs at the positive terminal 251 of a battery cell 220 and/or the battery-cell 220 can be configured such that thermal battery-cell event occurs at the positive terminal 251. Holes can be defined in the thermal protection shields 731, 732 in spatial alignment with the positive terminals 251 to allow heat, gas, and/or debris to flow into an air cavity 730 between the thermal protection shields 731, 732 of neighboring (e.g., immediately adjacent) battery-cell stacks 710. Pressure from heat and/or gas released during a thermal battery-cell event can be reduced by the air cavity 730. A first air cavity 730A is defined between the thermal protection shields 732, 731 of neighboring battery-cell stacks 710A, 710B, respectively. A second air cavity 730B is defined between the thermal protection shields 731, 732 of neighboring battery-cell stacks 710B, 710C, respectively.

A respective air channel 740 can be defined through each battery-cell stack 710. Each air channel 740 is fluidly coupled to and/or in fluid communication with the air cavity (ies) 730 adjacent to the respective battery-cell stack 710. For example, a first air channel 740A defined through battery-cell stack 710A is fluidly coupled to and/or in fluid communication with the first air cavity 730A. A second air channel 740B defined through battery-cell stack 710B is fluidly coupled to and/or in fluid communication with the first air cavity 730A and the second air cavity 730B. A third air channel 740C defined through battery-cell stack 710C is fluidly coupled to and/or in fluid communication with the second air cavity 730B. As such, the air cavities 730A, 730B and are fluidly coupled to and/or in fluid communication with each other through the air channel 740A-740C to form a battery-module air channel 750 that can further allow temperature and/or pressure to dissipate or be reduced from a thermal battery-cell event.

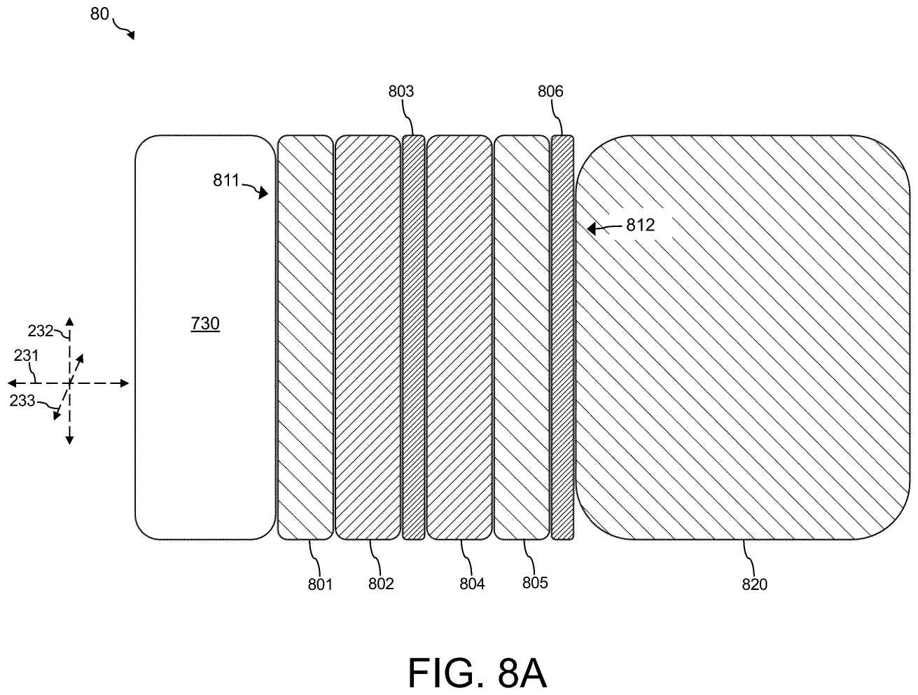

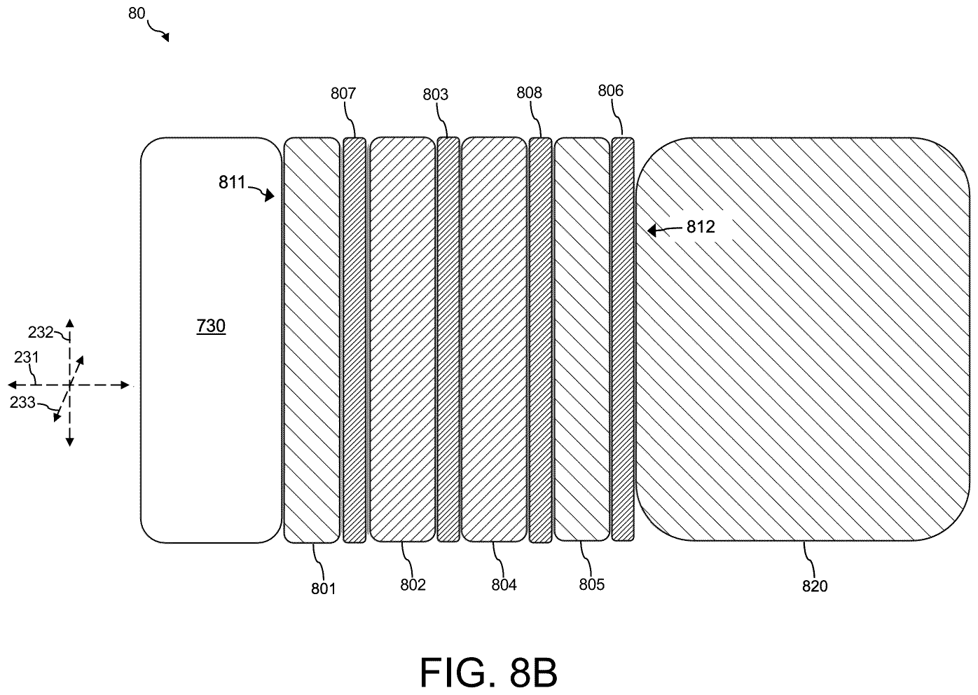

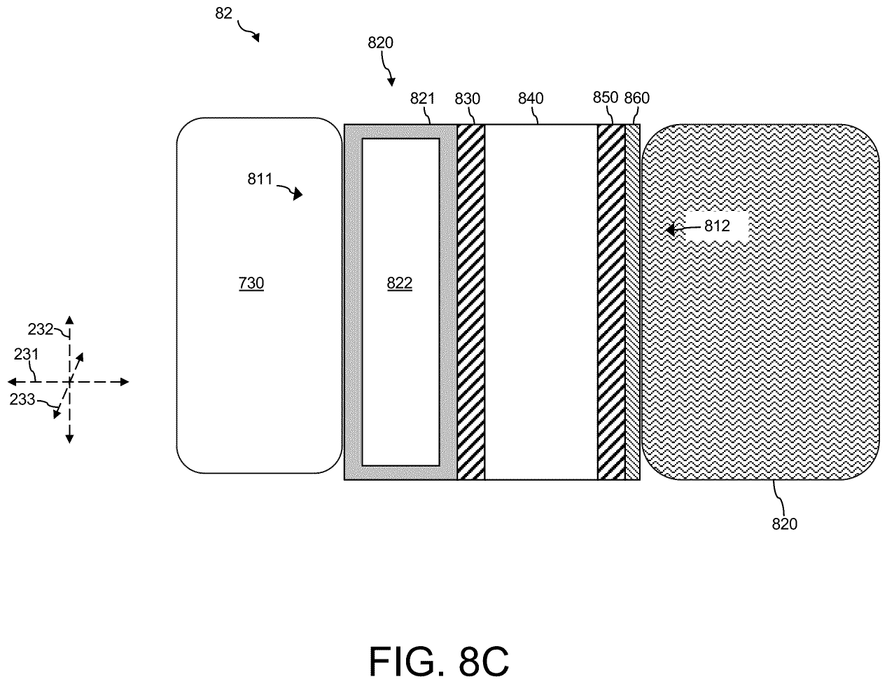

FIG. 8A is a block diagram of a thermal-protection shield 80 according to one or more embodiments. The thermal-protection shield 80 can be the same as a thermal-protection shield 731, 732. The thermal-protection shield 80 includes a first electrically insulating layer 801, a first heat absorption layer 802, a first adhesive layer 803, a second heat absorption layer 804, a second electrically insulating layer 805, and a second adhesive layer 806. In one or more embodiments, the thermal-protection shield 80 only includes one electrically insulating layer (e.g., only a first electrically insulating layer 801 or only a second electrically insulating layer 805).

The first electrically insulating layer 801 is disposed on and/or in direct physical contact with the first heat absorption layer 802. The first heat absorption layer 802 is disposed on and/or in direct physical contact with the first adhesive layer 803. In addition, the first heat absorption layer 802 is between and/or in direct physical contact with the first electrically insulating layer 801 and the first adhesive layer 803. The first adhesive layer 803 is disposed on and/or in direct physical contact with the second heat absorption layer 804. In addition, the first adhesive layer 803 is between and/or in direct physical contact with the first and second heat absorption layers 802, 804. The second heat absorption layer 804 is disposed on and/or in direct physical contact with the second electrically insulating layer 805. In addition, the second heat absorption layer 804 is between and/or in direct physical contact with the first adhesive layer 803 and the second electrically insulating layer 805. The second electrically insulating layer 805 is disposed on and/or in direct physical contact with the second adhesive layer 806. In addition, the second electrically insulating layer 805 is between and/or in direct physical contact with the second heat absorption layer 804 and the second adhesive layer 806.

In one or more embodiments, a third adhesive layer 807 is disposed between and/or in direct physical contact with the first electrically insulating layer 801 and the first heat absorption layer 802, for example as shown in FIG. 8B. Additionally or alternatively, a fourth adhesive layer 808 can be disposed between and/or in direct physical contact with the second electrically insulating layer 805 and the second heat absorption layer 804, as shown in FIG. 8B.

The first and second electrically insulating layers 801, 805 can each comprise an epoxy laminate layer or material, such as FR4, a plastic (e.g., a thermoplastic), mica, a powder coat (e.g., a powder coating of a material such as metal in the first and/or second heat absorption layers 802, 804) and/or another electrically insulating material. The first and second electrically insulating layers 801, 805 can prevent electrical short circuits from forming in the battery module during a thermal battery-cell event, for example due to conductive projectiles from the battery cell undergoing a thermal battery-cell event. The first and second electrically insulating layers 801, 805 can be thermally insulating in addition to electrically insulating. The first and second electrically insulating layers 801, 805 can be comprised or formed of the same or different material(s). The first and second heat absorption layers 802, 804 can comprise or be metal, such as steel (e.g., stainless steel), and/or another metal. The metal(s) can be powdered coated (e.g., powder-coated stainless steel) in one or more embodiments. The first and second heat absorption layers 802, 804 can comprise or consist of another material (e.g. a non-metal) such as graphite in one or more embodiments. The first and second heat absorption layers 802, 804 can have a high melting point (e.g., high temperature resistance), a high yield strength, a high durability, and a large heat capacity to maintain structural integrity and to absorb thermal energy during a thermal battery-cell event. The first and second heat absorption layers 802, 804 can be comprised or formed of the same or different material(s).

The first, second, and third adhesive layers 803, 806, 807 can comprise a bonding product, an adhesive, and/or an adhesive tape to adhere or bond the neighboring layers. The first, second, and third adhesive layers 803, 806, 807 can be comprised or formed of the same or different material(s). For example, the first adhesive layer 803 can adhere and/or bond the first and second heat absorption layers to one another. The second adhesive layer 803 can adhere and/or bond the first and second heat absorption layers 802, 804 to one another. The third adhesive layer 807 can adhere and/or bond the first electrically insulating layer 801 and the first heat absorption layer 802 to one another. The fourth adhesive layer 808 can adhere and/or bond the second electrically insulating layer 804 and the first heat absorption layer 804 to one another.

In one or more embodiments, the first and/or second electrically insulating layers 801, 805 can comprise and the respective first and second heat absorption layers 802, 804 can comprise an epoxy pre-preg reinforced and/or formed with a metal such as copper and/or steel (e.g., stainless steel.

In general, the first and second electrically insulating layers 801, 805 are configured to prevent electrical shorting between the battery cells 220 during a thermal battery-cell event, for example due to conductive projectiles from the battery cell undergoing a thermal battery-cell event. The first and second electrically insulating layers 801, 805 can also provide thermal insulation during a thermal battery-cell event. The first and second heat absorption layers 802, 804 are configured to absorb thermal heat that occurs during a thermal battery-cell event. The first and second heat absorption layers 802, 804 can be thermally conductive to conduct heat, away from the battery cells 220 (e.g., parallel to the second and/or third axes 232, 233).

In operation, the first electrically insulating layer 801 faces the air cavity 730 (FIG. 7) on a first side 811 of the thermal-protection shield 80 and provides a first thermal shielding layer. The heat or thermal energy that passes or conducts through the first electrically insulating layer 801 is reduced by the thermally conductive first and second heat absorption layers 802, 804. The second electrically insulating layer 805 functions as a second thermal shielding layer to further protect the battery cells 220 from thermal damage. The second adhesive layer 806 is on a second side 812 of the thermal-protection shield 80 and is attached to and/or in direct physical contact with an electrical bus layer 820, which can be the same as an electrical bus layer 721, 722.

In one or more embodiments, the first and second electrically insulating layers 801, 805 can each have a thickness, as measured relative to the first axis 231, of about 0.1 mm to about 2 mm, including about 0.5 mm, about 1 mm, about 1.5 mm, and any range or value between any two of the foregoing values. The first and second electrically insulating layers 801, 805 can have the same or different thicknesses. The first and second heat absorption layers 802, 804 can each have a thickness, as measured relative to the first axis 231, of about 0.1 mm to about 2 mm, including about 0.5 mm, about 1 mm, about 1.5 mm, and any range or value between any two of the foregoing values. In a specific embodiment, the first and second heat absorption layers 802, 804 can each have a thickness of about 0.6 mm. The total thickness of the thermal-protection shield 80, as measured relative to the first axis 231, can be about 0.2 mm to about 4 mm, including about 1 mm, about 2 mm, about 3 mm, and any range or value between any two of the foregoing values. As used herein, “about” means plus or minus 10% of a value or range.

FIG. 8C is a block diagram of a thermal-protection shield 82 according to one or other embodiments. The thermal-protection shield 82 can be the same as a thermal-protection shield 731, 732. The thermal-protection shield 82 includes a coated heat absorption layer 820, a first adhesive layer 830, an electrically insulating layer 840, a second adhesive layer 850, and a liner layer 860.

The coated heat absorption layer 820 includes a coating 821 disposed on and/or adhered to a heat absorption material 822. The coating 821 can comprise or can be an electrical insulator powder such as an epoxy powder. The coated heat absorption layer 820 can be the same as or different than a first or a second heat absorption layer 802, 804. The coating 821 can have a thickness, as measured with respect to the first or second axes 231, 232 (depending on where the thickness is measured), of about 0.1 mm to about 2 mm, including about 0.5 mm, about 1 mm, about 1.5 mm, and any range or value between any two of the foregoing values. The heat absorption material 822 can comprise steel, such as stainless steel (e.g., 18-8 stainless steel), copper, graphite, and/or another material. The heat absorption material 822 can have a thickness, as measured with respect to the first axis 231, of about 0.1 mm to about 2 mm, including about 0.5 mm, about 1 mm, about 1.5 mm, and any range or value between any two of the foregoing values. In a specific embodiment, the heat absorption material 822 can each have a thickness of about 0.6 mm.

The electrically insulating layer 840 can comprise or consist of an epoxy laminate layer or material, such as FR4, a plastic (e.g., a thermoplastic), mica, and/or another electrically insulating material. The electrically insulating layer 840 can be the same as or different than a first or a second electrically insulating layer 801, 805. The electrically insulating layer 840 can have a thickness, as measured with respect to the first axis 231, of about 0.1 mm to about 2 mm, including about 0.5 mm, about 1 mm, about 1.5 mm, and any range or value between any two of the foregoing values.

The first and second adhesive layers 830, 850 can be the same as or different than the first adhesive layer 803 and/or the second adhesive layer 806.

The liner layer 860 can comprise or consist of an electrically insulating material such as PET and/or another material. The liner layer 860 can have a thickness, as measured with respect to the first axis 231, of about 0.05 mm to about 0.25 mm, including about 0.1 mm, about 0.2 mm, and any range or value between any two of the foregoing values.

The coated heat absorption layer 820 is disposed on and/or in direct physical contact with the first adhesive layer 830. The first adhesive layer 830 is disposed on and/or in direct physical contact with the electrically insulating layer 840. In addition, the first adhesive layer 830 is disposed between and/or in direct physical contact with the coated heat absorption layer 820 and the electrically insulating layer 840. The electrically insulating layer 840 is disposed on and/or in direct physical contact with the second adhesive layer 850. In addition, the electrically insulating layer 840 is disposed between and/or in direct physical contact with the first and second adhesive layers 830, 850. The second adhesive layer 830 is disposed on and/or in direct physical contact with the liner layer 860. In addition, the second adhesive layer 830 is disposed between and/or in direct physical contact with the second adhesive layer 850 and the liner layer 860.

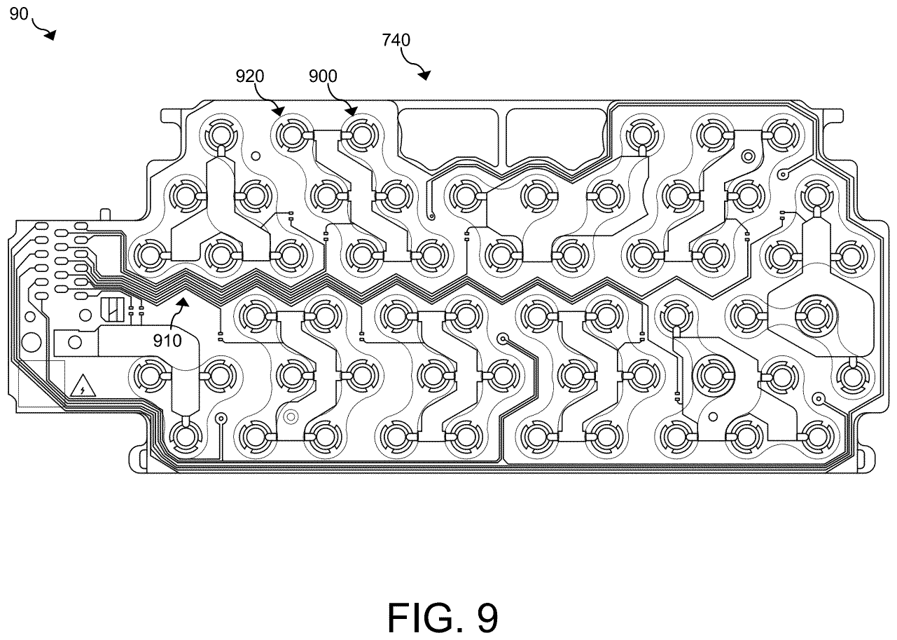

FIG. 9 is a top view of an electrical bus layer 90 according to one or more embodiments. The electrical bus layer 90 can be the same as an electrical bus layer 721, 722. The electrical bus layer 90 can alternately be referred to as an electrical wiring layer. The electrical bus layer 90 includes a plurality of electrically conductive caps 900 that are configured and arranged to electrically contact the terminals (e.g., positive terminal(s) 251 and/or negative terminal(s) 252) of the battery cells 220 on one side of a battery-cell stack (e.g., a battery-cell stack 710, 310, 210). Electrical wiring 910 is defined on the electrical bus layer 90 to electrically connect the conductive caps 900, for example in series, in parallel, and/or in another electrical circuit. One or more electrical wires can be electrically coupled to a BM controller 250 (FIG. 2) and/or to another electrical component or structure.

Holes or conduits 920 are defined around one or more portions of each conductive cap 900 to allow gas and/or pressure to escape from a battery cell 220 having a thermal battery-cell event. In one or more embodiments, the holes or conduits 910 are defined around one or more portions of only the conductive caps 900 that are spatially aligned with the positive terminals 252 on a respective side of a battery-cell stack. The air channels 740 (FIG. 7) are also shown in FIG. 9.

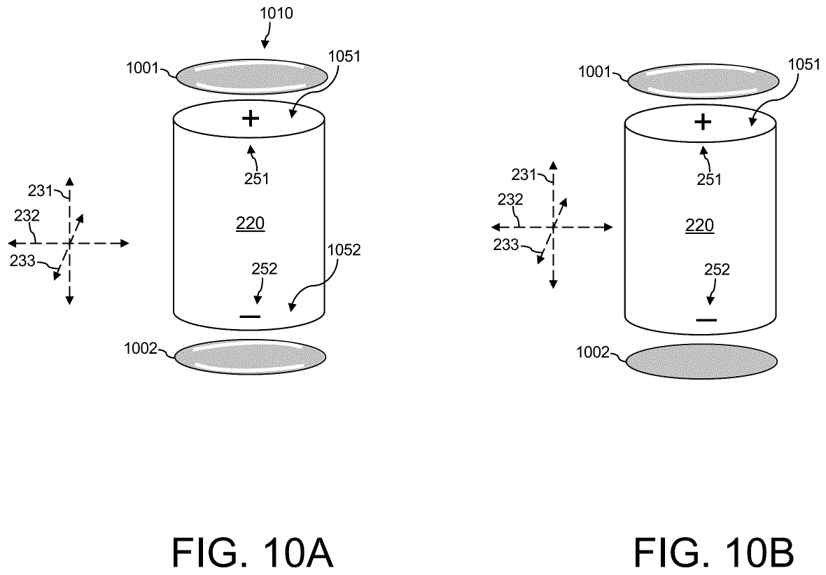

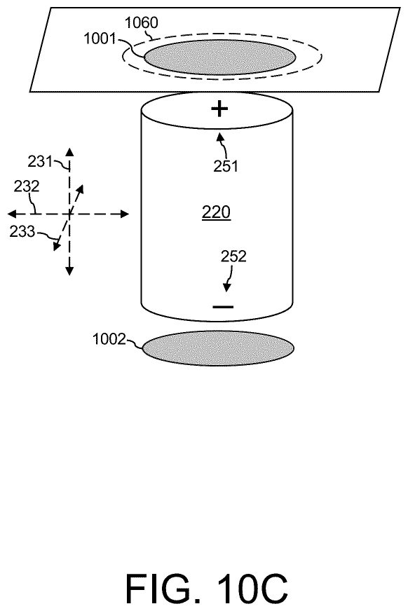

FIGS. 10A-10C are isolated exploded views of positive and negative conductive caps 1001, 1002 and an example battery cell 220 according to one or more alternative embodiments. The positive conductive cap 1001 is configured to electrically connect and/or electrically contact the positive terminal 251 of the battery cell 220. The negative conductive cap 1002 is configured to electrically connect and/or electrically contact the negative terminal 252 of the battery cell 220. In FIG. 10A, holes and/or conduits 1010 are defined in both the positive and negative conductive caps 1001, 1002. The holes and/or conduits 1010 are spatially aligned with respective portions 1051, 1052 of the positive and negative terminals 251, 252. For example, a first hole and/or conduit 1010 can be defined in the positive conductive cap 1001 (or more generally, in an electrical bus layer 90) and can be spatially aligned with a respective portion 1051 of the positive terminal 251. A second hole and/or conduit 1010 can be defined in the negative conductive cap 1002 (or more generally, in an electrical bus layer 90) and can be spatially aligned with a respective portion 1052 of the negative terminal 252.

In FIG. 10B, holes and/or conduits 1010 are defined in the positive conductive cap 1001 but not in the negative conductive cap 1002.

In FIG. 10C, holes and/or conduits 1010 are not defined in the positive conductive cap 1001 or in the negative conductive cap 1002. A perforation and/or scoring 1060 is defined around some or all of the positive conductive cap 1001. The perforation and/or scoring 1060 is configured to cause the positive conductive cap 1001 to break when the pressure or force caused by a thermal battery-cell event exceeds a threshold value, thus allow gas and/or thermal energy to escape from the positive terminal 251 towards an air cavity 730 (FIG. 7).

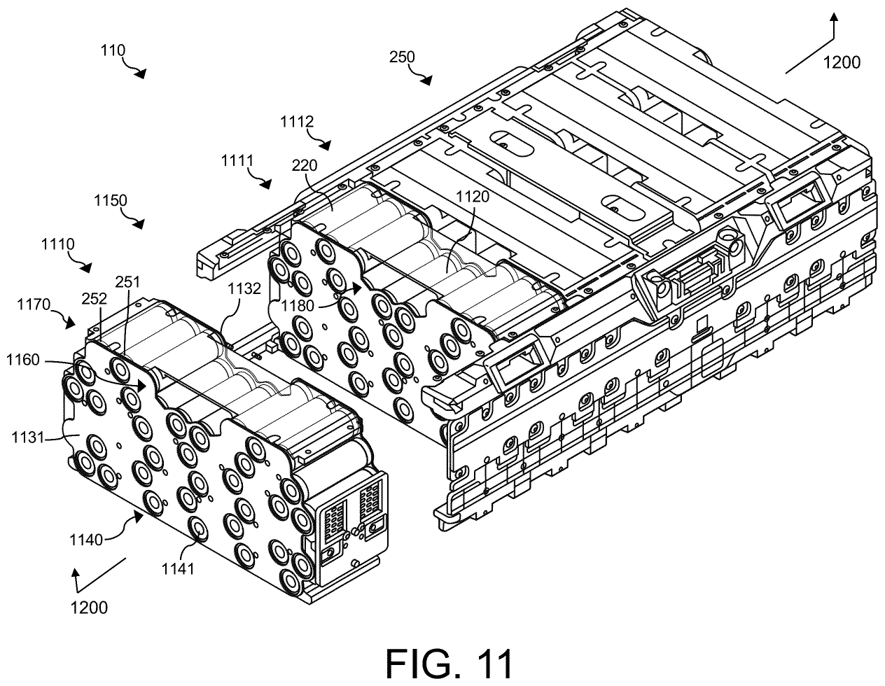

FIG. 11 is a partially exploded isometric view of a BM 110 according to one or more embodiments. The BM 110 includes a plurality of battery-cell stacks 1110 in which the battery cells 220 in each battery-cell stack 1110 is mounted and/or disposed in a respective support structure 1120. Each battery-cell stack 1110 can be the same as a battery-cell stack 710, 310, 210. Each support structure 1120 can be the same as a support structure 50.

First and second thermal-protection shields 1131, 1132 are disposed on and/or attached to first and second sides 1111, 1112 of each battery-cell stack 1110. The first and second thermal-protection shields 1131, 1132 can be the same as the first and second thermal-protection shields 731, 732 and/or the thermal-protection shield 80. Holes 1140 are defined in the first and second thermal-protection shields 1131, 1132 in spatial alignment with respective positive conductive caps 1141 so as to expose the positive conductive caps 1141. The positive conductive caps 1141 can be the same as the positive conductive cap 1001. The holes 1140 from respective channels between the positive conductive caps 1141 and an air cavity 1150 defined between the first and second thermal-protection shields 1131, 1132 of neighboring battery-cell stacks 1110. The air cavity 1150 can be the same as the air cavity 730. The air cavity 1150 is larger than normal in FIG. 11 due to the partially exploded view.

The first and second thermal-protection shields 1131, 1132 cover the negative conductive caps (not shown) at the negative terminals 252 of the battery cells 220. The first and second thermal-protection shields 1131, 1132, other than the holes 1140, can cover all or substantially all of the first and second sides 1111, 1112 of each battery-cell stack 1110 in spatial alignment with the battery cells 220.

A respective gap 1160 is defined in a top row 1170 of the battery cells 220 in each battery-cell stack 1110. The gap 1160 extends across the first and second sides 1111, 1112 of each battery-cell stack 1110 to form one or more air channels 1180 across each battery-cell stack 1110 that is/are fluidly coupled to and/or in fluid communication with one or more air cavity 1150 that are adjacent to and/or neighbor a respective battery-cell stack 1110 (e.g., the air cavity (ies) 1150 defined, in part, by the first and/or second thermal-protection shield 1131, 1132 attached to the respective battery-cell stack 1110 such as to first and second electrical bus layers 721, 722 (FIG. 7)). The air channel(s) 1180 across each battery-cell stack 1110 is/are spatially aligned along or relative to the first axis 251. In one or more alternative embodiments, one or more air channel(s) 1180 across a respective battery-cell stack 1110 can be spatially offset, along or relative to the second axis 252 and/or to the third axis 253, relative to one or more other air channel(s) 1180 across a respective other battery-cell stack(s) 1110. The air channel(s) 1180 can be the same as the air channels 740.

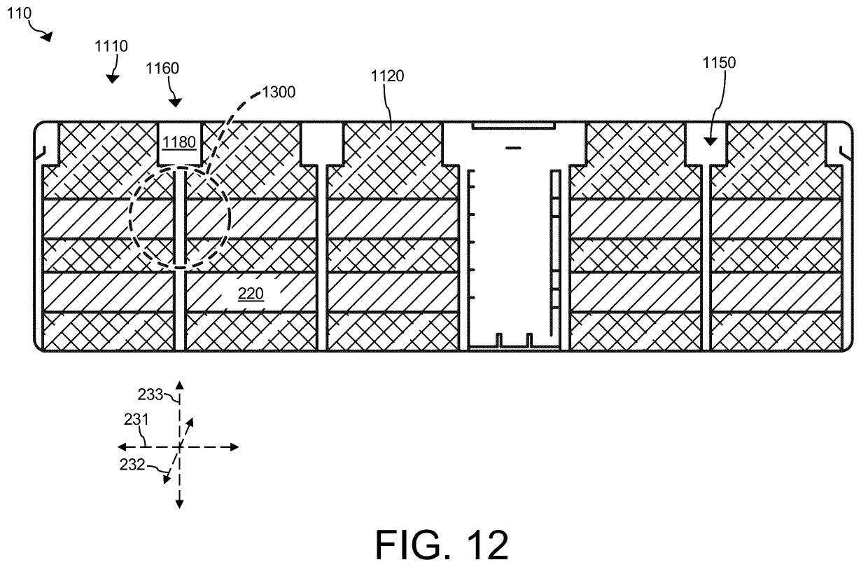

FIG. 12 is a simplified cross section of the BM 110 taken through plane 1200 in FIG. 11 according to one or more embodiments. Only two battery cells 220 in each battery-cell stack 1110 are shown in the cross section for illustration purposes only. It is understood each battery-cell stack 1110 can include additional battery cells 220 in one or more embodiments. The empty space 1200 is a plane in which the cross section shown in FIG. 12 comes from FIG. 11. Additionally or alternatively, the empty space 1200 can correspond to the BM controller 250.

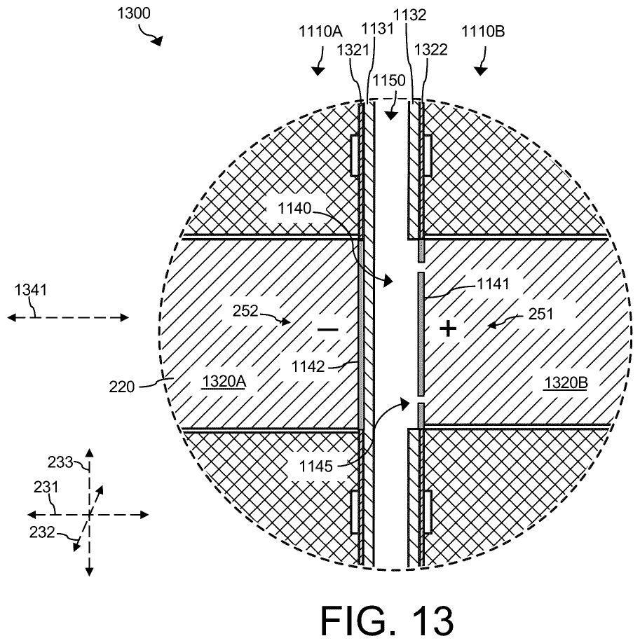

FIG. 13 is a detailed view of region 1300 in FIG. 12 according to one or more embodiments. The detailed view shows two spatially aligned battery cells (e.g., first and second battery cells) 220 having the same polarity orientation in first and second battery-cell stacks 1110A, 1110B. For ease of discussion, the spatially aligned battery cells 220 in first and second battery-cell stacks 1110A, 1110B are numbered as battery cells 1320A, 1320B, respectively. The negative terminal 252 of battery cell 1320A and the positive terminal 251 of battery cell 1320B face each other and are spatially aligned along a longitudinal axis.1341 that passes along the length of each battery cell 1320A, 1320B, the negative terminal 252 of battery cell 1320A, and the positive terminal 251 of battery cell 1320B. The longitudinal axis. 1341 is parallel or substantially parallel to (e.g., within about 5 degrees of) the first axis 231. Though not illustrated, the longitudinal axis.1341 also passes through the positive terminal 251 of battery cell 1320A and the negative terminal 252 of battery cell 1320B.

A negative cap 1142 in a first electrical bus layer 1321 is in electrical contact with the negative terminal 252 of battery cell 1320A. A positive cap 1141 in a second electrical bus layer 1322 is in electrical contact with the positive terminal 251 of battery cell 1320B. One or more holes or channels 1145 can be defined in the positive cap 1141 to expose a corresponding portion(s) of the positive terminal 251.

The first and second thermal-protection shields 1131, 1132 are disposed on, attached to, and/or in direct physical contact with the first and second electrical bus layers 1321, 1122, respectively. A hole 1140 is defined in the second thermal-protection shield 1132, in spatial alignment with the positive cap 1141 and positive terminal 251 of battery cell 1320B, to form a channel that can allow gas and/or thermal energy to escape from the positive terminal 251 of battery cell 1320B, in case of a thermal battery-cell event at/in battery cell 1320B, through the holes/channels 1140, 1145 into the air cavity 1150 while the first and second thermal-protection shields 1131, 1132 protect nearby battery cells 220 in the first and second battery-cell stacks 1110A, 1110B, including the spatially aligned battery cell 1320A, from excess thermal energy, debris, and/or gas from battery cell 1320B (e.g., from the positive terminal 251 of battery cell 1320B). A pressure increase due to thermal energy and/or gas from battery cell 1320B can be dissipated and/or equilibrated across the air cavities 1150 and air channels 1180 (e.g., as shown in FIGS. 11 and 12) of the BM 110.

The air cavity 1150 can have a length, as measured with respect to the first axis 231, of about 5 mm to about 10 mm, including about 5.5 mm, about 6 mm, about 7 mm, about 8mm, about 9 mm, and any value or range between any two of the foregoing values. The air cavity 1150 can be measured between the positive terminal 251 of a respective battery cell 220 to the external surface of the first thermal-protection shield 1131 along or parallel to the first axis 231.

Though the disclosure is written in terms of a thermal battery-cell event occurring at a positive terminal 251 of a battery cell 220 and/or the battery-cell 220 being configured such that any thermal battery-cell event occurs at the positive terminal 251, it is noted that a battery-cell 220 can be configured alternatively such that any thermal battery-cell event occurs at the negative terminal 252.

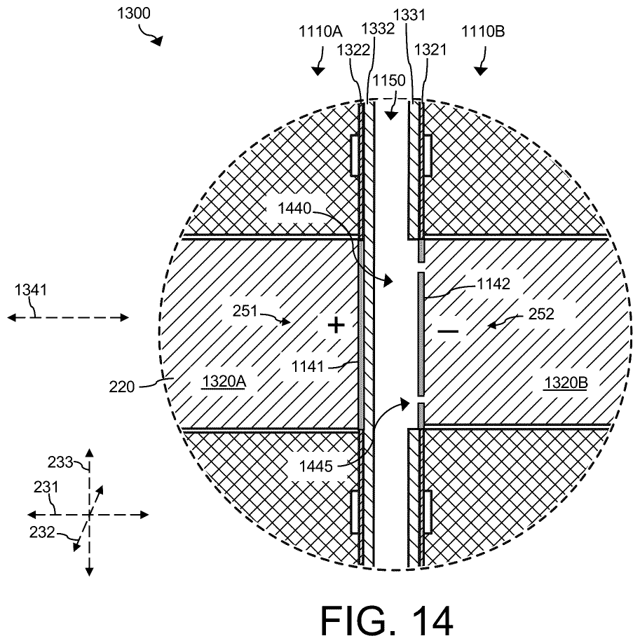

FIG. 14 is a detailed view of region 1300 in FIG. 12 according to one or more embodiments in which the battery cells 220, 1320A, 1320B are configured alternatively such that any thermal battery-cell event occurs at the negative terminal 252. One or more holes or channels 1445 is/are be defined in the negative cap 1142 to expose a corresponding portion(s) of the negative terminal 252 of battery cell 1320B. The negative cap 1142 in the first electrical bus layer 1321 is in electrical contact with the negative terminal 252 of battery cell 1320B. The positive cap 1141 in the second electrical bus layer 1322 is in electrical contact with the positive terminal 251 of battery cell 1320A.

The first and second thermal-protection shields 1131, 1132 are disposed on, attached to, and/or in direct physical contact with the first and second electrical bus layers 1321, 1122, respectively. A hole 1440 is defined in the first thermal-protection shield 1131, in spatial alignment with the negative cap 1141 and negative terminal 252 of battery cell 1320B, to form a channel that can allow gas and/or thermal energy to escape from the negative terminal 252 of battery cell 1320B, in case of a thermal battery-cell event at/in battery cell 1320B, through the holes/channels 1440, 1445 into the air cavity 1150 while the first and second thermal-protection shields 1131, 1132 protect nearby battery cells 220 in the first and second battery-cell stacks 1110A, 1110B, including the spatially aligned battery cell 1320A, from excess thermal energy, debris, and/or gas from battery cell 1320B (e.g., from the negative terminal 252 of battery cell 1320B). A pressure increase due to thermal energy and/or gas from battery cell 1320B can be dissipated and/or equilibrated across the air cavities 1150 and air channels 1180 (e.g., as shown in FIGS. 11 and 12) of the BM 110.

Thus, aspects of the invention safely protect a battery module from thermal propagation after a single battery cell goes through thermal runaway (e.g., a thermal battery-cell event). Multiple stacks of battery cells can be packaged very densely and yet the architecture still prevents thermal propagation when a single cell goes into thermal runaway. The battery module is configured to withstand a thermal battery-cell event at any location within the battery module. Thus, the mechanical architecture is configured with complimentary mechanical features to mitigate a thermal battery-cell event in densely packaged battery cells. When a battery cell goes into thermal runaway, the battery cell releases pressurized high-temperature gas and/or projectiles that can result in uncontrolled thermal propagation (e.g., to neighboring or nearby battery cells, which can themselves undergo respective thermal battery-cell events) and the destruction of the entire battery module. A safety mechanism for a battery module can includes some or all of the safety features described herein.

A first safety feature is that the battery module can be configured with adequate ventilation for flames and/or hot gasses. The ventilation system is designed such that hot gasses from the initiator cell (e.g., undergoing a thermal battery-cell event) can be released, and efficiently evacuated to the outside of the battery cell-stack and/or battery module and/or the rest of the system to protect adjacent battery cells within a stack from overheating.

A second safety feature is that the battery-stack support structure can be configured with sufficient strength and heat-dissipating properties. The battery-stack support structure can prevent side rupture of a battery cell during thermal runaway. If side rupture occurs, the battery-stack support structure still prevents hot gasses from releasing to the adjacent battery cells in the battery-stack support structure. Additionally or alternatively, the battery-stack support structure is thermally conductive to spread heat evenly throughout the battery-stack support and/or the battery module to reduce the amount of heat transmitted to adjacent and/or nearby battery cells.

A third safety feature is direct flame protection of some or all battery cells in the direct line-of-sight of venting flames and gasses venting from the positive terminal of each battery cell. To protect neighboring cells from overheating and causing a secondary thermal propagation event, a composite flame barrier can be designed with one or more of the following features. First, cutouts/holes can be precisely spatially aligned at the positive terminals of the battery cells to take advantage of the unidirectional venting of high temperature pressurized gasses and other ejecta from the cell undergoing thermal runaway (e.g., a thermal battery-cell event). Covering the positive terminal would result in side-rupture of the cells and uncontrolled thermal propagation. Second, the unidirectional venting of the positive end of one cell is paired with the flame barrier protecting the negative terminal of the immediately adjacent cell in the longitudinal direction. In one or more embodiments, there are no exceptions to this pairing to provide a mechanical architecture of the battery module to safely withstand a single cell thermal runaway at any location within the battery module. Third, the flame barrier can be a composite design that simultaneously withstands flame and heat to prevent punch-through/puncture, but also serves as an electrical insulating layer that prevents secondary shorts from possible conductive projectiles from the initial cell that undergoes thermal runaway.

### Example Embodiments

### Example 1

A battery module including a plurality of battery-cell stacks, each battery-cell stack including a plurality of battery cells, the battery cells arranged such that at least some positive terminals of the battery cells are disposed on a respective first side of a respective battery-cell stack and at least some negative terminals of the battery cells are disposed on a respective second side of the respective battery-cell stack, the respective first and second sides on opposing sides of the respective battery-cell stack; a plurality of first thermal-protection shields, each first thermal-protection shield disposed on the respective first side of the respective battery-cell stack; and a plurality of second thermal-protection shields, each second thermal-protection shield disposed on the respective second side of the respective battery-cell stack, wherein the battery-cell stacks include at least one neighboring battery-cell stack pair, a respective air gap is defined between (a) a respective first thermal-protection shield on the respective first side of a first battery-cell stack in a respective battery-cell stack pair and (b) a respective second thermal-protection shield on the respective second side of a second battery-cell stack in the respective battery-cell stack pair, a plurality of holes are defined in each first thermal-protection shield, the holes spatially aligned with the at least some positive terminals on the respective first side of the first battery-cell stack in each battery-cell stack pair such that each positive terminal on the respective first side of each first battery-cell stack is at least partially fluidly coupled to the respective air gap, and the respective second thermal-protection shield covers the at least some negative terminals on the respective second side of the second battery-cell stack in each battery-cell stack pair such that each negative terminal on the respective second side of each second battery-cell stack is shielded from a thermal event occurring at any of the at least some positive terminals on the respective first side of each first battery-cell stack.

### Example 2

The battery module of Example 1, wherein each of the first and second thermal protection shields comprises first and second electrically insulating layers and at least one absorption disposed between the first and second electrically insulating layers.

### Example 3

The battery module of any of the preceding Examples, wherein the epoxy laminate, mica, and the at least one heat absorption layer comprises metal and/or graphite

### Example 4

The battery module of any of the preceding Examples, wherein the metal comprises stainless steel.

### Example 5

The battery module of any of the preceding Examples, further comprising a plurality of support frames, each support frame defining a plurality of battery-cell cavities, each battery-cell cavity in a respective support frame configured to receive a respective battery cell from the respective battery-cell stack.

### Example 6

The battery module of any of Example 5, wherein each support frame is comprised of one or more metals.

### Example 7

The battery module of any of the preceding Examples, wherein the battery cells in the battery-cell stacks are spatially aligned along longitudinal axes, each longitudinal axis passing through respective terminals of a respective battery cell in each battery-cell stack.

### Example 8

The battery module of any of the preceding Examples, wherein respective battery cells that are spatially aligned along a respective longitudinal axis have the same polarity orientation.

### Example 9

The battery module of any of the preceding Examples, wherein a respective air channel is defined through each support frame, each air channel fluidly coupled to the respective air gap.

### Example 10

A battery module including a plurality of battery-cell stacks, each battery-cell stack including battery cells, the battery cells in the battery-cell stacks spatially aligned along longitudinal axes, each longitudinal axis passing through respective terminals of a respective battery cell in each battery-cell stack, the longitudinal axes parallel to one another; a plurality of first electrical wiring layers, each first electrical wiring layer disposed on a first side of a respective battery-cell stack and in electrical contact with each battery cell in the respective battery-cell stack; a plurality of second electrical wiring layers, each second electrical wiring layer disposed on a second side of the respective battery-cell stack and in electrical contact with each battery cell in the respective battery-cell stack; a plurality of first thermal-protection shields, each first thermal-protection shield disposed on a respective first electrical wiring layer; and a plurality of second thermal-protection shields, each second thermal-protection shield disposed on a respective second electrical wiring layer, wherein the battery-cell stacks include at least one neighboring battery-cell stack pair, a respective air gap is defined between (a) a respective first thermal-protection shield on the first side of a first battery-cell stack in a respective battery-cell stack pair and (b) a respective second thermal-protection shield on the second side of a second battery-cell stack in the respective battery-cell stack pair, a plurality of first channels are defined in the respective first thermal-protection shield, each first channel fluidly coupling a respective positive terminal of each battery cell that has the respective positive terminal on the first side of the first battery-cell stack in the respective battery-cell stack pair to the respective air gap, and a plurality of second channels are defined in the respective second thermal-protection shield, each second channel fluidly coupling the respective positive terminal of each battery cell that has the respective positive terminal on the second side of the second battery-cell stack in the respective battery-cell stack pair to the respective air gap.

### Example 11

The battery module of Example 10, wherein respective battery cells that are spatially aligned along a respective longitudinal axis have the same polarity orientation.

### Example 12

The battery module of Example 10 or 11, wherein a plurality of first holes are defined in each first electrical wiring layer, each first hole spatially aligned with the respective positive terminal of each battery cell that has the respective positive terminal on the first side of the respective battery-cell stack, and a plurality of second holes are defined in each second electrical wiring layer, each second hole spatially aligned with the respective positive terminal of each battery cell that has the respective positive terminal on the second side of the respective battery-cell stack.

### Example 13

The battery module of any of Examples 10-12, wherein each first electrical wiring layer includes a plurality of first positive electrical tabs, each first positive electrical tab configured to electrically contact the respective positive terminal of each battery cell that has the respective positive terminal on the first side of the respective battery-cell stack, wherein each first hole is defined in a respective first positive electrical tab, and each second electrical wiring layer includes a plurality of second positive electrical tabs, each second positive electrical tab configured to electrically contact the respective positive terminal of each battery cell that has the respective positive terminal on the second side of the respective battery-cell stack, wherein each second hole is defined in a respective second positive electrical tab.

### Example 14

The battery module of any of Examples 10-13, wherein each first electrical wiring layer includes a plurality of first negative electrical tabs, each first negative electrical tab configured to electrically contact a respective negative terminal of each battery cell that has the respective negative terminal on the first side of the respective battery-cell stack, and each second electrical wiring layer includes a plurality of second negative electrical tabs, each second negative electrical tab configured to electrically contact the respective negative terminal of each battery cell that has the respective negative terminal on the second side of the respective battery-cell stack.

### Example 15

The battery module of any of Examples 10-14, wherein the first and second holes are first and second positive holes, respectively, a plurality of first negative holes are defined in each first electrical wiring layer, each first negative hole spatially aligned with the respective negative terminal of each battery cell that has the respective negative terminal on the first side of the respective battery-cell stack, each first negative hole defined in a respective first negative electrical tab, and a plurality of second negative holes are defined in each second electrical wiring layer, each second negative hole spatially aligned with the respective negative terminal of each battery cell that has the respective negative terminal on the second side of the respective battery-cell stack, each second negative hole defined in a respective second negative electrical tab.

### Example 16

A battery module including a plurality of support frames, each support frame defining a plurality of battery-cell cavities; a plurality of battery cells, each battery cell disposed in a respective battery-cell cavity of a respective support frame to form a plurality of battery-cell stacks, the support frames configured such that each battery cell is oriented such that a respective axis passes through the respective terminals of a respective battery cell, the respective axes parallel to one another; a plurality of first electrical wiring layers, each first electrical wiring layer disposed on a first side of a respective battery-cell stack and in electrical contact with each battery cell in the respective battery-cell stack; a plurality of second electrical wiring layers, each second electrical wiring layer disposed on a second side of the respective battery-cell stack and in electrical contact with each battery cell in the respective battery-cell stack; a plurality of first thermal-protection shields, each first thermal-protection shield disposed on a respective first electrical wiring layer; and a plurality of second thermal-protection shields, each second thermal-protection shield disposed on a respective second electrical wiring layer, wherein a respective air gap is defined between (a) a respective first thermal-protection shield on the first side of a first battery-cell stack in a respective neighboring battery-cell stack pair and (b) a respective second thermal-protection shield on the second side of a second battery-cell stack in the respective neighboring battery-cell stack pair, the battery cells in each battery-cell stack include one or more first battery cells, each first battery cell oriented such that a respective positive terminal of a respective first battery cell is on the first side of the respective battery-cell stack and a respective negative terminal of the respective first battery cell is on the second side of the respective battery-cell stack, the battery cells in each battery-cell stack include one or more second battery cells, each second battery cell oriented such that the respective positive terminal of a respective second battery cell is on the second side of the respective battery-cell stack and the respective negative terminal of the respective second battery cell is on the first side of the respective battery-cell stack, each negative terminal on the second side of the second battery-cell stack is spatially aligned with the respective positive terminal on the first side of the second battery-cell stack, one or more first holes are defined in each first electrical wiring layer, each first hole spatially aligned with the respective positive terminal of the respective first battery cell, and one or more second holes are defined in each second electrical wiring layer, each second hole spatially aligned with the respective positive terminal of the respective second battery cell.

### Example 17

The battery module of Example 16, wherein each of the first and second thermal protection shields comprises first and second electrically insulating layers and at least one absorption disposed between the first and second electrically insulating layers.

### Example 18

The battery module of Example 16 or 17, wherein a respective air channel is defined through each support frame, each air channel fluidly coupled to the respective air gap.

### Example 19

The battery module of any of Examples 15-17, wherein the respective air channels through the support frames are spatially aligned.

### Example 20

An electric vehicle including an interface plate attached to a bottom of the electric vehicle, the interface plate electrically coupled to a drive train of the electric vehicle; a battery tray releasably attached to the interface plate; and the battery module of any of Examples 1-19, the battery module disposed on the battery tray and electrically coupled to the interface plate.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A battery module comprising:
a plurality of battery-cell stacks, each battery-cell stack including a plurality of battery cells, the battery cells arranged such that at least some positive terminals of the battery cells are disposed on a respective first side of a respective battery-cell stack and at least some negative terminals of the battery cells are disposed on a respective second side of the respective battery-cell stack, the respective first and second sides on opposing sides of the respective battery-cell stack;
a plurality of first thermal-protection shields, each first thermal-protection shield disposed on the respective first side of the respective battery-cell stack; and
a plurality of second thermal-protection shields, each second thermal-protection shield disposed on the respective second side of the respective battery-cell stack,
wherein:
the battery-cell stacks include at least one neighboring battery-cell stack pair,
a respective air gap is defined between (a) a respective first thermal-protection shield on the respective first side of a first battery-cell stack in a respective battery-cell stack pair and (b) a respective second thermal-protection shield on the respective second side of a second battery-cell stack in the respective battery-cell stack pair,
a plurality of holes are defined in each first thermal-protection shield, the holes spatially aligned with the at least some positive terminals on the respective first side of the first battery-cell stack in each battery-cell stack pair such that each positive terminal on the respective first side of each first battery-cell stack is at least partially fluidly coupled to the respective air gap, and
the respective second thermal-protection shield covers the at least some negative terminals side on the respective second side of the second battery-cell stack in each battery-cell stack pair such that each negative terminal on the respective second side of each second battery-cell stack is shielded from a thermal event occurring at any of the at least some positive terminals on the respective first side of each first battery-cell stack.

2. The battery module of claim 1, wherein each of the first and second thermal protection shields comprises first and second electrically insulating layers and at least one heat absorption layer disposed between the first and second electrically insulating layers.

3. The battery module of claim 2, wherein:
the first and second electrically insulating layers comprise an epoxy laminate, mica, and/or a thermoplastic, and
the at least one heat absorption layer comprises metal and/or graphite.

4. The battery module of claim 3, wherein the metal comprises stainless steel.

5. The battery module of claim 1, further comprising a plurality of support frames, each support frame defining a plurality of battery-cell cavities, each battery-cell cavity in a respective support frame configured to receive a respective battery cell from the respective battery-cell stack.

6. The battery module of claim 5, wherein each support frame is comprised of one or more metals.

7. The battery module of claim 1, wherein the battery cells in the battery-cell stacks are spatially aligned along longitudinal axes, each longitudinal axis passing through respective terminals of a respective battery cell in each battery-cell stack.

8. The battery module of claim 7, wherein respective battery cells that are spatially aligned along a respective longitudinal axis have the same polarity orientation.

9. The battery module of claim 7, wherein a respective air channel is defined through each support frame, each air channel fluidly coupled to the respective air gap.

10. A battery module comprising:
a plurality of battery-cell stacks, each battery-cell stack including battery cells, the battery cells in the battery-cell stacks spatially aligned along longitudinal axes, each longitudinal axis passing through respective terminals of a respective battery cell in each battery-cell stack, the longitudinal axes parallel to one another;
a plurality of first electrical wiring layers, each first electrical wiring layer disposed on a first side of a respective battery-cell stack and in electrical contact with each battery cell in the respective battery-cell stack;
a plurality of second electrical wiring layers, each second electrical wiring layer disposed on a second side of the respective battery-cell stack and in electrical contact with each battery cell in the respective battery-cell stack;
a plurality of first thermal-protection shields, each first thermal-protection shield disposed on a respective first electrical wiring layer; and
a plurality of second thermal-protection shields, each second thermal-protection shield disposed on a respective second electrical wiring layer,
wherein:
the battery-cell stacks include at least one neighboring battery-cell stack pair,
a respective air gap is defined between (a) a respective first thermal-protection shield on the first side of a first battery-cell stack in a respective battery-cell stack pair and (b) a respective second thermal-protection shield on the second side of a second battery-cell stack in the respective battery-cell stack pair,
a plurality of first channels are defined in the respective first thermal-protection shield, each first channel fluidly coupling a respective positive terminal of each battery cell that has the respective positive terminal on the first side of the first battery-cell stack in the respective battery-cell stack pair to the respective air gap, and
a plurality of second channels are defined in the respective second thermal-protection shield, each second channel fluidly coupling the respective positive terminal of each battery cell that has the respective positive terminal on the second side of the second battery-cell stack in the respective battery-cell stack pair to the respective air gap.

11. The battery module of claim 10, wherein respective battery cells that are spatially aligned along a respective longitudinal axis have the same polarity orientation.

12. The battery module of claim 10, wherein:
a plurality of first holes are defined in each first electrical wiring layer, each first hole spatially aligned with the respective positive terminal of each battery cell that has the respective positive terminal on the first side of the respective battery-cell stack, and
a plurality of second holes are defined in each second electrical wiring layer, each second hole spatially aligned with the respective positive terminal of each battery cell that has the respective positive terminal on the second side of the respective battery-cell stack.

13. The battery module of claim 12, wherein:
each first electrical wiring layer includes a plurality of first positive electrical tabs, each first positive electrical tab configured to electrically contact the respective positive terminal of each battery cell that has the respective positive terminal on the first side of the respective battery-cell stack, wherein each first hole is defined in a respective first positive electrical tab, and
each second electrical wiring layer includes a plurality of second positive electrical tabs, each second positive electrical tab configured to electrically contact the respective positive terminal of each battery cell that has the respective positive terminal on the second side of the respective battery-cell stack, wherein each second hole is defined in a respective second positive electrical tab.

14. The battery module of claim 13, wherein:
each first electrical wiring layer includes a plurality of first negative electrical tabs, each first negative electrical tab configured to electrically contact a respective negative terminal of each battery cell that has the respective negative terminal on the first side of the respective battery-cell stack, and
each second electrical wiring layer includes a plurality of second negative electrical tabs, each second negative electrical tab configured to electrically contact the respective negative terminal of each battery cell that has the respective negative terminal on the second side of the respective battery-cell stack.

15. The battery module of claim 14, wherein:
the first and second holes are first and second positive holes, respectively,
a plurality of first negative holes are defined in each first electrical wiring layer, each first negative hole spatially aligned with the respective negative terminal of each battery cell that has the respective negative terminal on the first side of the respective battery-cell stack, each first negative hole defined in a respective first negative electrical tab, and
a plurality of second negative holes are defined in each second electrical wiring layer, each second negative hole spatially aligned with the respective negative terminal of each battery cell that has the respective negative terminal on the second side of the respective battery-cell stack, each second negative hole defined in a respective second negative electrical tab.

16. A battery module comprising:
a plurality of support frames, each support frame defining a plurality of battery-cell cavities;
a plurality of battery cells, each battery cell disposed in a respective battery-cell cavity of a respective support frame to form a plurality of battery-cell stacks, the support frames configured such that each battery cell is oriented such that a respective axis pass through the respective terminals of a respective battery cell, the respective axes parallel to one another;
a plurality of first electrical wiring layers, each first electrical wiring layer disposed on a first side of a respective battery-cell stack and in electrical contact with each battery cell in the respective battery-cell stack;
a plurality of second electrical wiring layers, each second electrical wiring layer disposed on a second side of the respective battery-cell stack and in electrical contact with each battery cell in the respective battery-cell stack;
a plurality of first thermal-protection shields, each first thermal-protection shield disposed on a respective first electrical wiring layer; and
a plurality of second thermal-protection shields, each second thermal-protection shield disposed on a respective second electrical wiring layer,
wherein:
a respective air gap is defined between (a) a respective first thermal-protection shield on the first side of a first battery-cell stack in a respective neighboring battery-cell stack pair and (b) a respective second thermal-protection shield on the second side of a second battery-cell stack in the respective neighboring battery-cell stack pair,
the battery cells in each battery-cell stack includes one or more first battery cells, each first battery cell oriented such that a respective positive terminal of a respective first battery cell is on the first side of the respective battery-cell stack and a respective negative terminal of the respective first battery cell is on the second side of the respective battery-cell stack,
the battery cells in each battery-cell stack includes one or more second battery cells, each second battery cell oriented such that the respective positive terminal of a respective second battery cell is on the second side of the respective battery-cell stack and the respective negative terminal of the respective second battery cell is on the first side of the respective battery-cell stack,
each negative terminal on the second side of the second battery-cell stack is spatially aligned with the respective positive terminal on the first side of the second battery-cell stack,
one or more first holes is/are defined in each first electrical wiring layer, each first hole spatially aligned with the respective positive terminal of the respective first battery cell, and
one or more second holes is/are defined in each second electrical wiring layer, each second hole spatially aligned with the respective positive terminal of the respective second battery cell.

17. The battery module of claim 16, wherein each of the first and second thermal protection shields comprises first and second electrically insulating layers and at least one heat absorption layer disposed between the first and second electrically insulating layers.

18. The battery module of claim 16, wherein a respective air channel is defined through each support frame, each air channel fluidly coupled to the respective air gap.

19. The battery module of claim 18, wherein the respective air channels through the support frames are spatially aligned.

20. An electric vehicle comprising:
an interface plate attached to a bottom of the electric vehicle, the interface plate electrically coupled to a drive train of the electric vehicle;
a battery tray releasably attached to the interface plate; and
the battery module of claim 16, the battery module disposed on the battery tray and electrically coupled to the interface plate.
